(19) United States
(12) Patent Application Publication
(10) Pub. No.: US 2025/0002373 A1
(43) Pub. Date: Jan. 2, 2025

(54) FILTER ASSEMBLY

(71) Applicant: COWAY CO., LTD., Gongju-si (KR)

(72) Inventors: Geun Sang RYU, Gongju-si (KR); Sung Han YUN, Gongju-si (KR); Tae Hun MOON, Gongju-si (KR); Doo Won HAN, Gongju-si (KR); Jung Hun LEE, Gongju-si (KR)

(73) Assignee: COWAY CO., LTD., Gongju-si (KR)

(21) Appl. No.: 18/705,170

(22) PCT Filed: Oct. 12, 2022
(86) PCT No.: PCT/KR2022/015371

§ 371 Date: Apr. 26, 2024

(30) Foreign Application Priority Data
Nov. 3, 2021 (KR) 10-2021-0150024
Nov. 30, 2021 (KR) 10-2021-0169319
Nov. 30, 2021 (KR) 10-2021-0169358
Dec. 13, 2021 (KR) 10-2021-0177478

(51) Int. Cl. C02F 1/00

(52) U.S. Cl. CPC C02F 1/003; C02F 2307/10

(57) ABSTRACT

A filter assembly includes a housing having an accommodation space formed therein so as to communicate with an external raw water supply unit and a purified water discharge unit, respectively; a filter unit formed to extend from one direction toward the other direction and accommodated in the accommodation space of the housing such that raw water supplied from the external raw water supply unit is filtered, thereby generating purified water; and a cover unit accommodated in the accommodation space of the housing so as to support the filter unit.

### TECHNICAL FIELD

The present invention relates to a filter assembly for purified water, and more particularly, to a filter assembly capable of producing purified water by filtering raw water in various ways while minimizing its size.

### BACKGROUND

A water purifier refers to an apparatus that receives raw water from outside, filters it to the water quality desired by the user, and discharges it. As interest in improving health and quality of life increases, there is an increasing demand to drink clean water by installing a water purifier not only in public places such as offices but also in homes.

Water purifiers are generally equipped with a filter as a member for filtering raw water. Filters generate purified water by filtering foreign substances and components mixed in raw water in a physical and chemical manner. The generated purified water may be discharged to the outside by a user's manipulation or the like so that the user may drink it.

A typical filter is configured to filter water in either a physical, chemical or electrical manner. In this case, it is difficult to remove foreign substances or microorganisms or the like contained in water at a time.

Accordingly, recently released water purifiers are increasingly provided with a plurality of filters. Raw water passes through the plurality of filters at the same time or at different times, and is filtered in various ways and produced as purified water. A filter formed by combining a plurality of filters as described above is often referred to as a composite filter.

As can be easily expected, since the composite filter includes a plurality of filters, the space occupied by the composite filter becomes excessive compared to the space occupied by a single filter. Therefore, when a composite filter is provided, there is a problem in that the total volume of the water purifier is also increased, reducing ease of installation and increasing the manufacturing cost.

Specifically, if it is configured so that raw water passes through a plurality of filters sequentially, a space in which the plurality of filters are to be placed and a member for communicating the plurality of filters with each other are required. In addition, if it is configured so that raw water passes through a plurality of filters simultaneously, problems related to the reliability of the filtration process, the removal of filtered foreign substances, and so on arise.

Accordingly, techniques for filtering raw water using a plurality of filters have been introduced.

Korean Registered Utility Model Document No. 20-0402257 discloses a filter apparatus for a water purifier. Specifically, this document discloses a filter apparatus for a water purifier with a structure in which multiple filtering processes can be performed using a first filtering part and a second filtering part provided inside the first filtering part. In particular, the prior document discloses that the second filtering part provided on the inside may be provided as a hollow fiber membrane filter.

However, this type of filter apparatus for water purifiers cannot suggest a method for providing a hollow fiber membrane filter on the outside. That is, in the case of a hollow fiber membrane filter, a plurality of hollow fibers having a minimal cross-section are formed by combining them. However, the above prior document does not suggest a way to prevent twisting between the hollow fibers constituting the hollow fiber membrane filter when it is placed on the outside.

Japanese Patent Laid-Open Publication No. 2019-098256 discloses a filter module. Specifically, it discloses a filter module for simultaneously removing dissolved gases and solids in a liquid, including a cylindrical hollow fiber membrane filter.

However, this type of filter module is formed by winding hollow fibers in the form of a kind of bunch. That is, the hollow fiber membrane filter of the filter module disclosed in the above-mentioned prior document has a hollow formed inside, and the hollow fiber surrounding the hollow extends in a spiral shape.

In addition, the prior document does not disclose whether other types of filters can be additionally provided in addition to the hollow fiber membrane filter.

Korean Patent Registration No. 10-2299939 discloses a submerged membrane filtering apparatus for wastewater treatment. Specifically, it discloses a submerged membrane filtering apparatus for wastewater treatment with a structure capable of improving the durability of a separation membrane module installed in the membrane filtering apparatus. The prior document discloses a structure for preventing twisting between hollow fiber membranes by placing a plurality of hollow fiber membranes spaced apart from each other.

However, the application of this type of submerged membrane filtering apparatus is limited to wastewater use. In other words, raw water and wastewater to be filtered into purified water have differences in their components and mixtures, so it is difficult to apply the submerged membrane filtering apparatus suggested in the prior document to the water purification process for drinking.

In addition, in the submerged membrane filtering apparatus disclosed in the above-described prior document, a plurality of hollow fiber membranes are arranged to be spaced apart from each other in the width direction or breadth direction of the membrane filtering apparatus. This structure inevitably causes an increase in the size of the space occupied by the hollow fiber membrane and the overall size of the submerged membrane filtering apparatus. Korean Registered Utility Model Document No. 20-0402257 (2005.11.29.) Japanese Patent Laid-open Publication No. 2019-098256 (2019.06.24.) Korean Patent Registration No. 10-2299939 (2021.09.07.)

### SUMMARY OF THE INVENTION

### Technical Problem

The purpose of the present invention is to provide a filter assembly with a structure that can solve the above-mentioned problems.

First, the present invention is directed to providing a filter assembly with a structure that can generate purified water by filtering raw water in various ways.

In addition, the present invention is directed to providing a filter assembly with a structure that can minimize increase in volume while filtering raw water in various ways.

In addition, the present invention is directed to providing a filter assembly with a structure in which a coupling structure of members for filtering raw water can be formed simply.

In addition, the present invention is directed to providing a filter assembly with a structure in which members for filtering raw water can be stably supported.

In addition, the present invention is directed to providing a filter assembly with a structure that can prevent random mixing of raw water and purified water formed by filtering raw water.

In addition, the present invention is directed to providing a filter assembly with a structure that is easy to use and maintain.

In addition, as the need for miniaturized water purifiers increases, the present invention is directed to providing a filter assembly that can minimize the volume occupied by the carbon filter and hollow fiber membrane filter in the water purifier.

In addition, the present invention is directed to providing a filter assembly that can be easily replaced from the frame.

In addition, the present invention is directed to providing a filter assembly that can effectively remove contaminants blocking the micropores of the hollow fiber membrane filter when the hollow fiber membrane filter is used for a long period of time.

In addition, the present invention is directed to providing a filter assembly that can reduce the size by combining multiple filters while ensuring excellent microbial removal performance.

In addition, the present invention is directed to providing a filter assembly configured so that different filters can be replaced at once.

### Technical Solution

According to an aspect of the present invention, provided is a filter assembly, including: a housing having an accommodation space formed therein so as to communicate with an external raw water supply unit and a purified water discharge unit, respectively; a filter unit formed to extend from one direction toward the other direction and accommodated in the accommodation space of the housing such that raw water supplied from the external raw water supply unit is filtered, thereby generating purified water; and a cover unit accommodated in the accommodation space of the housing so as to support the filter unit, wherein the filter unit includes: a first filtering part configured such that the raw water supplied thereto is filtered while passing therethrough primarily; and a second filtering part made of a different material from the first filtering part and positioned radially inside of the first filtering part such that the raw water that has passed through the first filtering part is filtered while passing therethrough secondarily, wherein the first filtering part is formed to surround the radial outside of the second filtering part while being spaced apart from the second filtering part, and is provided as a hollow fiber membrane comprising multiple strips, wherein the strip includes: one end and the other end positioned to be biased in the one direction; and at least one curved portion continuous with the one end and the other end and positioned biased in the other direction, and wherein the supplied raw water is filtered while passing through the first filtering part and the second filtering part, and is produced as purified water.

In this case, a filter assembly may be provided in which the supplied raw water enters a hollow part extending inside the strip through a plurality of through holes formed on an outer circumferential surface of the strip and is filtered.

In addition, a filter assembly may be provided in which the one end of the strip is positioned adjacent to the radial outer side of the first filtering part, and the other end of the strip is positioned adjacent to the radial inner side of the first filtering part.

In this case, a filter assembly may be provided in which the plurality of strips are arranged such that a virtual straight line connecting the one end and the other end of any one of the plurality of strips intersects at least one point with a virtual straight line connecting the one end and the other end of the other one of the plurality of strips.

In addition, a filter assembly may be provided in which the filter unit extends in an up-down direction, and the strip includes: one end positioned adjacent to the radial outer side of the first filtering part, on the upper side of the filter unit; a curved portion continuous with the one end and positioned adjacent to the lower side of the filter unit; and the other end that is continuous with the curved portion, and is spaced apart from the one end and positioned adjacent to the radial inner side of the first filtering part, on the upper side of the filter unit.

In this case, a filter assembly may be provided in which the housing includes: an inlet part through which the raw water supply unit and the accommodation space of the housing are communicated with each other to supply the raw water; the filter unit is formed to extend in a direction away from the inlet part; and a main communication hole, which is positioned adjacent to one end from which the filter unit extends, and is formed open to communicate the accommodation space into which the raw water is introduced and the inside of the first filtering part is formed on the radially outer surface of the first filtering part.

In addition, a filter assembly may be provided in which the filter unit includes: a discharge hollow part formed on a radial inner side of the second filtering part along its axial direction, and through which the purified water, produced by filtering the raw water while the raw water passing through the second filtering part, flows.

In this case, a filter assembly may be provided in which the filter unit is formed to extend from one direction toward the other direction, and the cover unit includes: a first cover supporting an end of the filter unit in the one direction; and a second cover supporting an end of the filter unit in the other direction.

In addition, according to an aspect of the present invention, provided is a filter assembly, including: a housing with a space formed therein; a first filtering part accommodated inside the housing and providing purified water by filtering raw water; and a second filtering part for filtering the raw water or the purified water,
wherein the first filtering part includes a plurality of hollow fibers, and includes a filter member that is spaced apart a predetermined distance outside the second filtering part when viewed from the top and extends to surround at least a portion of the second filtering part, wherein each of the plurality of hollow fibers has a fiber passage extending along the longitudinal direction of the hollow fiber for the raw water to flow, and both ends of the fiber passage extend to be open toward opposite sides.

In this case, a filter assembly may be provided in which the plurality of hollow fibers extend in the up-down direction so that one end of the fiber passage is open toward the upper side and the other end opposite to the one end is open toward the lower side.

In addition, a filter assembly may be provided in which the first filtering part further includes a fiber support supporting the filter member, a raw water flow path extending in the up-down direction is formed between the inner circumferential surface of the housing and the outer circumferential surface of the fiber support, and a communication hole is formed in the fiber support for water to be introduced from the raw water flow path toward the filter member.

In this case, a filter assembly may be provided in which when viewed from the top, the first filtering part extends in a ring shape, and the second filtering part is disposed inside the ring of the filter member in the radial direction.

In addition, according to an aspect of the present invention, provided is a filter assembly, including: a housing with a space formed therein; a first filtering part accommodated inside the housing and providing purified water by filtering raw water; and a second filtering part for filtering the raw water or the purified water, wherein the first filtering part includes a plurality of hollow fibers, and includes a filter member that is spaced apart a predetermined distance outside the second filtering part when viewed from the top and extends to surround at least a portion of the second filtering part, wherein each of the plurality of hollow fibers has a fiber passage extending along the longitudinal direction of the hollow fiber for the raw water to flow, and both ends of the fiber passage are bent to be open toward the same side.

In this case, a filter assembly may be provided in which the filter member includes a first filter member and a second filter member disposed below the first filter member, and the plurality of hollow fibers include first fibers provided to the first filtering member and second fibers provided to the second filtering member, wherein the first fiber is bent so that both ends of a first passage formed in the first fiber are open upward, and the second fiber is bent so that both ends of a second passage formed in the second fiber are open downward.

In addition, a filter assembly may be provided in which when viewed from the top, the first filtering part extends in a ring shape, and the second filtering part is disposed inside the ring of the filter member in the radial direction.

In addition, according to an aspect of the present invention, provided is a filter assembly, including: a housing with a space formed therein; a first filtering part accommodated inside the housing and providing purified water by filtering raw water; a second filtering part for filtering the purified water; and a third filtering part comprising a positively charged layer for filtering the purified water, wherein the first filtering part include a plurality of hollow fibers, and is spaced apart a predetermined distance outside the second filtering part and the third filtering part when viewed from the top and extends to surround at least a portion of the second filtering part and the third filtering part.

In this case, a filter assembly may be provided in which when viewed from the top, the third filtering part extends to surround at least a portion of the second filtering part.

In addition, a filter assembly may be provided in which the second filtering part includes a carbon filter.

In this case, a filter assembly may be provided in which a cap disposed inside the housing to support the first filtering part, the third filtering part, and the second filtering part is further included, wherein the cap include: an upper cap member supporting the upper sides of the first filtering part, the second filtering part, and the third filtering part, and being disposed to be spaced apart by a predetermined distance from the upper end of the first filtering part; and a lower cap member supporting the lower side of the first filtering part, the lower side of the second filtering part, and the lower side of the third filtering part.

In addition, a filter assembly may be provided in which an inlet through which the raw water is introduced and an outlet through which the purified water is discharged are formed in the housing, one of the inlet and the outlet is formed on one surface of the housing, and the other is formed on the one surface of the housing or the other surface opposite to the one surface.

### Advantageous Effects

According to an exemplary embodiment of the present invention, the following effects can be achieved.

First, the filter assembly is equipped with a filter unit for filtering raw water to produce purified water. The filter unit can include a plurality of filtering parts that filter raw water in different ways. In an embodiment, the filter unit includes a first filtering part provided as a hollow fiber membrane filter and a second filtering part provided as a hollow fiber membrane filter or another type of filter. In an embodiment in which the second filtering part is provided as a hollow fiber membrane filter, the sizes of the hollow fibers of the first filtering part and the hollow fiber of the second filtering part can be formed differently.

Raw water flowing into the filter assembly passes through one of the plurality of filtering parts and is filtered to produce first purified water. The first purified water passes through another one of the plurality of filtering parts and is filtered to produce second purified water.

Therefore, raw water flowing into the filter assembly is filtered multiple times in different ways to produce purified water. Accordingly, the filtered purified water can be maintained in a state more suitable for drinking by users.

In addition, the first filtering part and the second filtering part constituting the filter unit are arranged to overlap along the radial direction. That is, in an embodiment, the first filtering part is located radially outside the second filtering part and is formed to surround the second filtering part. The first filtering part is formed to have an annular cross-section with a hollow formed therein. The second filtering part is accommodated in the hollow formed inside the first filtering part and filters the first purified water passing through the first filtering part into second purified water.

Therefore, it is sufficient to secure only a space equal to the volume of the first filtering part in order to provide both the first filtering part and the second filtering part. Accordingly, the size of the space required to filter raw water in various ways can be reduced, and the size of the filter unit and the filter assembly including the same can be miniaturized.

In addition, the filter assembly includes a housing having a space therein. Inside the housing, the above-described filter unit and a cover unit that supports the filter unit and form a flow path together with the filter unit are provided.

The cover unit is removably coupled to both ends of the filter unit in the extension direction. The cover unit is configured to support a plurality of filtering parts provided in the filter unit from both sides, respectively. The cover unit can be coupled to the housing, and the filter unit can also be coupled to the housing.

Therefore, the coupling of the housing, the cover unit, and the filter unit constituting the filter assembly can be easily formed.

In addition, the cover unit includes a plurality of covers supporting one end and the other end of the filter unit. Each cover includes a plate part placed to cover each end of the filter unit, an outer circumferential part supporting the outer circumference of the first filtering part located radially outside, and an inner circumferential part supporting the inner circumference of the first filtering part and the outer circumference of the second filtering part.

Furthermore, the cover located at the lower side includes a cover boss part that is formed through the inside of the second filtering part and is inserted and coupled to a discharge hollow part that forms a flow path of second purified water.

Therefore, the cover unit can support the filter unit at a plurality of positions and at a plurality of points. Accordingly, the filter unit can be stably supported and maintained at a predetermined position regardless of the flow of raw water, first purified water, or second purified water.

In addition, the cover unit is coupled to the housing. Any one cover of the cover unit forms a part of a path that communicates the inner space of the housing with the outside. Another cover of the cover unit supports the filter unit and forms a part of a flow path of the filtered purified water.

A discharge hollow part is formed through the inside of the filter unit. The second purified water filtered while passing through both the first filtering part and the second filtering part flows in the discharge hollow part. One end of the ends in the extension direction of the discharge hollow part facing the one cover is formed open to communicate with the outside. The other end of the ends in the extension direction of the discharge hollow part facing the other cover is closed by being inserted and coupled by a cover boss part provided in the cover unit.

Therefore, only second purified water that has gone through all the filtration processes can flow into the discharge hollow part and be discharged to the outside. Therefore, the water purification reliability of the fluid discharged from the filter assembly can be improved.

Also, in an embodiment, the housing, the cover unit, and the filter unit constituting the filter assembly can be combined in a module form. If maintenance is required, only one or more members of the housing, the cover unit, and the filter unit can be removed and then replaced with a new member.

Furthermore, the first filtering part and the second filtering part constituting the filter unit can also be provided in a module form. As the use of the water purifier proceeds, only the filtering part requiring maintenance among the first filtering part and the second filtering part can be removed from the filter unit and then replaced with a new filtering part.

Therefore, it is easy to use and maintain, and the economic cost required for maintenance of the filter assembly can be reduced, thereby improving user satisfaction.

In addition, the filter assembly according to an exemplary embodiment of the present invention can minimize the volume occupied by the carbon filter and the hollow fiber membrane filter in the water purifier as the need for a miniaturized water purifier increases.

In addition, in the filter assembly according to an exemplary embodiment of the present invention, the filter assembly can be easily replaced from the frame.

In addition, the filter assembly according to an exemplary embodiment of the present invention can efficiently remove contaminants blocking the micropores of the hollow fiber membrane filter when the hollow fiber membrane filter is used for a long period of time.

In addition, the filter assembly according to an exemplary embodiment of the present invention can reduce the size of the filter while securing excellent microbial removal performance by efficiently removing bacteria, viruses, chemicals or the like contained in raw water.

In addition, in the filter assembly according to an exemplary embodiment of the present invention, different filters can be replaced at once, thereby securing ease of replacement.

### BRIEF DESCRIPTION OF THE DRAWINGS

FIG. 1 is a perspective view illustrating a water purifier according to an exemplary embodiment of the present invention.

FIG. 2 is a conceptual diagram illustrating components of a water purifier including a filter assembly according to an exemplary embodiment of the present invention.

FIG. 3 is a partially transparent perspective view illustrating a filter assembly according to a first embodiment of the present invention.

FIG. 4 is a front cross-sectional view illustrating a filter assembly according to an exemplary embodiment of the present invention.

FIG. 5 is a plan cross-sectional view illustrating a filter assembly according to an exemplary embodiment of the present invention.

FIG. 6 is a perspective view illustrating a filter assembly according to another exemplary embodiment of the present invention.

FIG. 7 is a perspective view illustrating a filter assembly according to yet another exemplary embodiment of the present invention.

FIG. 8 is a cross-sectional view illustrating a flow path of raw water and purified water formed by a filter assembly according to an exemplary embodiment of the present invention.

FIG. 9 is a cross-sectional view illustrating a flow path of raw water and purified water formed by a filter assembly according to another exemplary embodiment of the present invention.

FIG. 10 is a cross-sectional view illustrating a flow path of raw water and purified water formed by a filter assembly according to yet another exemplary embodiment of the present invention.

FIG. 11 is a cross-sectional view illustrating a cross-section of a filter assembly according to a second embodiment of the present invention.

FIG. 12 is a view illustrating a flow of raw water and purified water in a purified water discharge mode.

FIG. 13 is a cross-sectional view taken along line A-A′ of FIG. 11.

FIG. 14 is an enlarged view of part B in FIG. 11.

FIG. 15 is a perspective view and a partial enlarged view of the hollow fiber of FIG. 13.

FIG. 16 is a cross-sectional view taken along line C-C′ of FIG. 15.

FIG. 17 is a view illustrating a flow of raw water and purified water in a backflushing mode.

FIG. 18 is a cross-sectional view illustrating a cross-section of a filter assembly according to a third embodiment of the present invention.

FIG. 19 is a view illustrating a flow of raw water and purified water in a purified water discharge mode.

FIG. 20 is a cross-sectional view taken along line A-A′ of FIG. 18.

FIG. 21 is an enlarged view of part B in FIG. 18.

FIG. 22 is an enlarged view of part C in FIG. 18.

FIG. 23 is a perspective view and a partial enlarged view of the hollow fiber of FIG. 20.

FIG. 24 is a cross-sectional view taken along line D-D′ of FIG. 21.

FIG. 25 is an enlarged view of part E in FIG. 18.

FIG. 26 is a view illustrating a flow of raw water and purified water in a backflushing mode.

FIG. 27 is a view illustrating a water purifier including a filter assembly according to a fourth embodiment of the present invention.

FIG. 28 is a cross-sectional view of a filter assembly cut along line A-A′ of FIG. 27.

FIG. 29 is a view illustrating a hollow fiber of a filter assembly according to yet another exemplary embodiment of the present invention.

FIG. 30 is a cross-sectional view of the hollow fiber cut along line C-C′ of FIG. 29.

FIG. 31 is an enlarged view of B in FIG. 27.

### DETAILED DESCRIPTION OF THE EMBODIMENTS

Hereinafter, a filter assembly 10, 21, 22, 23 for purification according to an exemplary embodiment of the present invention will be described in detail with reference to the accompanying drawings.

In the following description, in order to clarify the features of the present invention, descriptions of some components may be omitted.

### 1. Term Definition

The term “communication” used in the following description means that one or more members are connected to each other so as to be in fluid communication. In an embodiment, communication may be formed by a member such as a conduit, a pipe, a tubing, or the like.

The term “energization” used in the following description means that one or more members are connected to each other so as to transmit an electric current or an electric signal. In an embodiment, the energization may be formed in a wired form by a wire member or the like or in a wireless form such as Bluetooth, Wi-Fi, RFID, or the like.

The term “raw water” used in the following description refers to any fluid supplied without going through a filtering process for the user to drink or use as water for life. In an embodiment, the raw water may be tap water.

The term “filtration or filtering” used in the following description refers to any treatment process applied to raw water to be used as water for the user to drink or live. In an embodiment, filtration may include a process for removing foreign substances or any substances in the raw water in a physical, chemical, or electrical manner.

The term “purified water” used in the following description refers to any fluid that a user can drink among fluids generated by filtering raw water. The term purified water may be used as a meaning including both first purified water and second purified water below.

The term “first purified water” used in the following description refers to purified water generated by filtering raw water by one of the first filtering part 310 and the second filtering part 320 constituting the filter unit 300.

The term “second purified water” used in the following description refers to purified water generated by filtering raw water by both the first filtering part 310 and the second filtering part 320 constituting the filter unit 300.

The term “second purified water” used in the following description refers to purified water generated by filtering again as the first purified water introduced into the filter assembly 10 is discharged from the filter assembly 10.

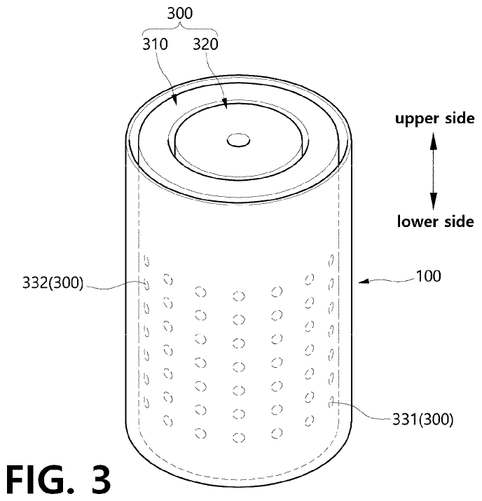

The terms “upper side or upwards” and “lower side or downwards” used in the following description will be understood with reference to the coordinate system shown in FIG. 3.

### 2. Description of a Water Purifier 1 Including a Filter Assembly 10, 21, 22, 23 According to an Exemplary Embodiment of the Present Invention

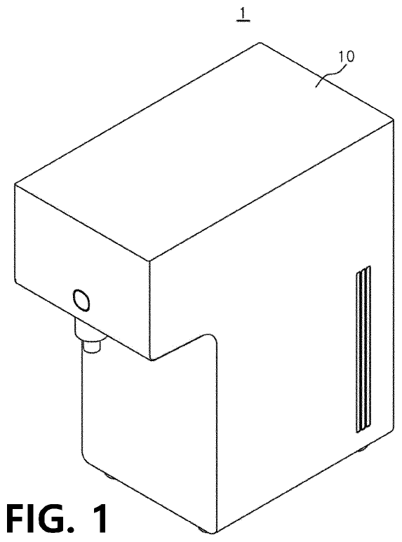

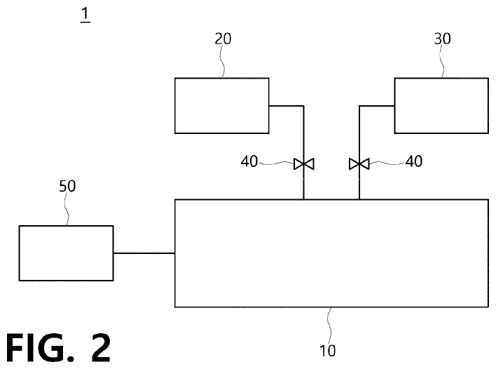

Referring to FIGS. 1 to 2, a configuration of a water purifier 1 according to an exemplary embodiment of the present invention is illustrated.

The water purifier 1 may receive raw water from the outside. To this end, the water purifier 1 communicates with an external raw water supply source (not shown). The above raw water supply source (not shown) may be configured to communicate with the raw water supply unit 20 to transmit the raw water to the raw water supply unit 20 apart from the raw water supply unit 20 shown in FIGS. 1 and 2.

In the illustrated embodiment, the water purifier 1 includes a filter assembly 10, a raw water supply unit 20, a purified water discharge unit 30, a valve unit 40, and a control unit 50.

The filter assembly 10 filters raw water in different ways to generate purified water. The filter assembly 10 may include at least two filters of different types.

The filter assembly 10 communicates with the raw water supply unit 20. The filter assembly 10 may filter raw water introduced from the raw water supply unit 20.

The filter assembly 10 communicates with the purified water discharge unit 30. The purified water generated by the filter assembly 10 may be discharged to the outside through the purified water discharge unit 30.

The filter assembly 10 is energized with the control unit 50. The control unit 50 may control the filter assembly 10 and other components of the water purifier 1 in a physical manner, an electrical manner, and various other ways.

Details of the filter assembly 10, 21, 22, 23 will be described separately.

The raw water supply unit 20 receives raw water from an external raw water supply source (not shown). The received raw water is delivered to the filter assembly 10, filtered into purified water, and then delivered to the user.

In the illustrated embodiment, the raw water supply unit 20 is shown as being included as a component of the water purifier 1. Alternatively, it will be understood that if the water purifier 1 is provided as a direct water type, the raw water supply unit 20 may be replaced with an external water pipe or the like.

The purified water discharge unit 30 discharges purified water formed by filtering raw water to the outside. The user can discharge purified water by manipulating the purified water discharge unit 30 or the control unit 50 configured to control the purified water discharge unit 30. The purified water discharge unit 30 communicates with the filter assembly 10.

The valve unit 40 allows or blocks communication between each component of the water purifier 1. The valve unit 40 is provided between the components communicating with each other among the components of the water purifier 1, that is, between the filter assembly 10 and the raw water supply unit 20 and between the filter assembly 10 and the purified water discharge unit 30, respectively, in the illustrated embodiment.

The valve unit 40 may allow or block communication between the components. The above process may be automatically performed by the control unit 50 or may be achieved through user manipulation.

The valve unit 40 may be provided in any form that allows or blocks communication between two or more members in communication with each other. In an embodiment, the valve unit 40 may be configured to be operated by an electrical signal or physical manipulation.

The control unit 50 automatically or manually controls the operation of the valve unit 40. The control unit 50 is energizably connected to the valve unit 40.

In an embodiment in which the control unit 50 manually controls the operation of the valve unit 40, the control unit 50 may include an input module (not shown) to be operated by a user. The user may apply a control signal to control the valve unit 40 by physically manipulating the input module (not shown) or by applying an electrical signal to the input module (not shown).

Since the process of controlling the valve unit 40 by the control unit 50 is a well-known technology, detailed description thereof will be omitted.

### 3. Description of the Configuration of the Filter Assembly 10 According to the First Embodiment of the Present Invention

The filter assembly 10 according to the first embodiment of the present invention is in communication with the raw water supply unit 20 and the purified water discharge unit 30, respectively. The filter assembly 10 receives raw water from the raw water supply unit 20, filters it, and discharges the filtered purified water to the outside through the purified water discharge unit 30.

The filter assembly 10 may be composed of two or more different filtering parts. Raw water flowing into the filter assembly 10 may be filtered in at least two different ways to produce purified water.

Accordingly, raw water can be produced more effectively and into purified water suitable for drinking.

The filter assembly 10 may be provided as a module constituting the water purifier 1. That is, the filter assembly 10 may be removably coupled to the water purifier 1 to communicate with or be energized with other components.

Therefore, the filter assembly 10 may be easily removed from other components by the user or combined with other components to constitute the water purifier 1.

Hereinafter, the configuration of the filter assembly 10 according to the first embodiment of the present invention will be described in detail with reference to FIGS. 3 to 7.

In the illustrated embodiment, the filter assembly 10 includes a housing 100, a cover unit 200, and a filter unit 300.

The housing 100 forms the outer shape of the filter assembly 10. A space is formed inside the housing 100 so that various components of the filter assembly 10 can be mounted therein.

The space of the housing 100 communicates with the outside. Specifically, the space of the housing 100 communicates with the raw water supply unit 20 and the purified water discharge unit 30. Raw water may be introduced into the space of the housing 100. The introduced raw water may be purified by the filter unit 300 and delivered to the user through the purified water discharge unit 30.

The housing 100 may be formed of a rigid body. That is, the housing 100 may not be deformed in shape by an external force or pressure, an internal force or pressure.

The housing 100 may have any shape in which a space is formed therein to mount various components of the filter assembly 10. In the illustrated embodiment, the housing 100 has a cylindrical shape having a circular cross-section and extending in the up-down direction.

In the illustrated embodiment, the housing 100 includes an accommodation space 110, a housing opening 120, and a housing boss part 130.

The accommodation space 110 is a space formed inside the housing 100. The accommodation space 110 is partially surrounded by the outer circumference of the housing 100, and at least one side is open to communicate with the outside.

In the illustrated embodiment, the horizontal direction of the accommodation space 110 is surrounded by the outer circumference of the housing 100. The lower side of the accommodation space 110 is surrounded by the bottom surface of the housing 100, and the upper side of the accommodation space 110 is partially open to communicate with the outside.

The cover unit 200 and the filter unit 300 are accommodated in the accommodation space 110. The cover unit 200 and the filter unit 300 are accommodated in the accommodation space 110 and are not arbitrarily exposed to the outside.

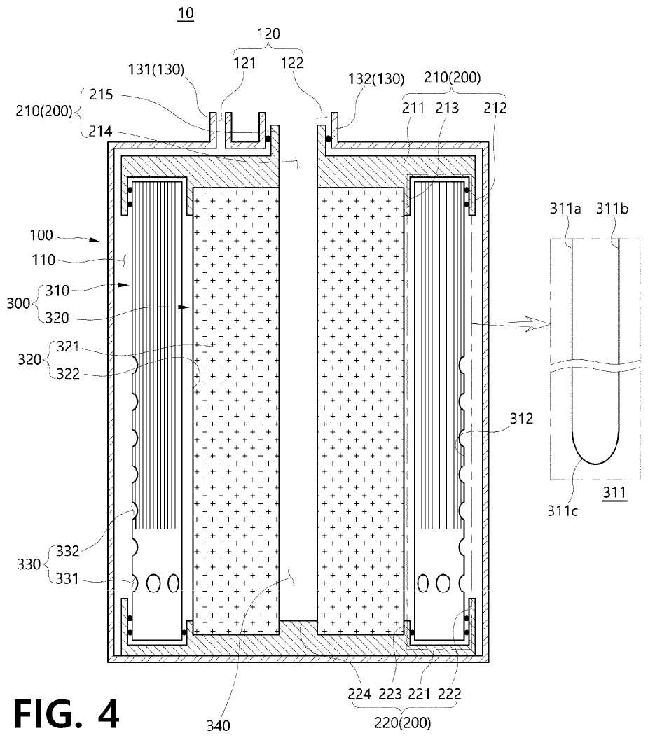

The accommodation space 110 may be divided into a plurality of spaces. Raw water may flow in some of the plurality of spaces. In the embodiment illustrated in FIG. 4, raw water flows in a space adjacent to the outer circumferential surface of the housing 100.

First purified water may flow in some other part of the plurality of spaces. In the embodiment illustrated in FIG. 4, first purified water flows in a space adjacent to the first filtering part 310 of the filter unit 300.

Second purified water may flow in another part of the plurality of spaces. In the embodiment illustrated in FIG. 4, second purified water flows in a space adjacent to the second filtering part 320 of the filter unit 300, that is, a space adjacent to the center of the filter unit 300.

The housing opening 120 is formed at the upper side of the accommodation space 110. The accommodation space 110 communicates with the outside through the housing opening 120.

The housing opening 120 communicates the accommodation space 110 with the outside. The housing opening 120 is formed through the outer circumferential surface of the housing 100. In the illustrated embodiment, the housing opening 120 is formed through the upper surface of the housing 100.

A plurality of housing openings 120 may be formed. At least one of the plurality of housing openings 120 may function as a passage for communicating the raw water supply unit 20 with the accommodation space 110. At least the other one of the plurality of housing openings 120 may function as a passage for communicating the purified water discharge unit 30 with the accommodation space 110.

The illustrated embodiment provides two housing openings 120, including an inlet part 121 and an outlet part 122.

The inlet part 121 is formed to be open to communicate the accommodation space 110 with the raw water supply unit 20. Raw water may be delivered from the raw water supply unit 20 to the accommodation space 110 through the inlet part 121.

The inlet part 121 may extend in the extension direction of the housing 100. In the illustrated embodiment, the inlet part 121 is formed to extend in the up-down direction. The inlet part 121 may be partially surrounded by the housing boss part 130, specifically, an inlet boss part 131.

Referring to FIG. 4, the upper side of the inlet part 121 is formed open, the lower side of the inlet part 121 communicates with the accommodation space 110, and the outer side of the inlet 121 in the radial direction is surrounded by the inner circumferential surface of the inlet boss part 131.

Therefore, the inlet part 121 may be formed inside the inlet boss part 131 and defined as a hollow surrounded by the inner circumferential surface thereof.

A detailed description of the process in which raw water flows through the inlet part 121 will be described later.

The outlet part 122 is formed to be open to communicate the accommodation space 110 with the purified water discharge unit 30. Purified water, specifically second purified water, may be delivered from the accommodation space 110 to the purified water discharge unit 30 through the outlet part 122.

The outlet part 122 may extend in the extension direction of the housing 100. In the illustrated embodiment, the outlet part 122 is formed to extend in the up-down direction. It will be understood that the extension direction of the outlet part 122 is the same as the extension direction of the inlet part 121. The outlet part 122 may be partially surrounded by the housing boss part 130, specifically, an outlet boss part 132.

Referring back to FIG. 4, the upper side of the outlet part 122 is formed open, the lower side of the outlet part 122 communicates with the accommodation space 110, and the outer side of the outlet 122 in the radial direction is surrounded by the inner circumferential surface of the outlet boss part 132.

Therefore, the outlet part 122 may be formed inside the outlet boss part 132 and defined as a hollow surrounded by the inner circumferential surface thereof.

A detailed description of the process in which second purified water flows out through the outlet part 122 will be described later.

The inlet part 121 and the outlet part 122 may be formed to be physically spaced apart. That is, the inlet part 121 and the outlet part 122 do not directly communicate with each other. Therefore, raw water flowing in the inlet part 121 and second purified water flowing in the outlet part 122 are not mixed.

The housing boss part 130 defines the housing opening 120 by partially surrounding the housing opening 120. The housing boss part 130 may be formed to extend to the outside of the housing 100 and may be coupled to any member (not shown) for communication with the external raw water supply unit 20 or purified water discharge unit 30.

The housing boss part 130 is formed to extend outward from the outer surface of the housing 100. The housing boss part 130 may be formed on a surface of the outer surface of the housing 100 in which the housing opening 120 is formed. In the illustrated embodiment, the housing boss part 130 is formed to extend from the upper side of the housing 100.

A plurality of housing boss parts 130 may be provided. Any one of the plurality of housing boss parts 130 may be connected to the raw water supply unit 20. The other one of the plurality of housing boss parts 130 may be connected to the purified water discharge unit 30.

The illustrated embodiment provides two housing boss parts 130, including an inlet boss part 131 and an outlet boss part 132.

The inlet boss part 131 extends to surround one of the housing openings 120, the inlet part 121 in the illustrated embodiment. The inlet boss part 131 may be connected to the raw water supply unit 20, so that the raw water supply unit 20 and the inlet part 121 may communicate with each other.

The inlet boss part 131 is formed to extend outward from an one surface of the housing 100, the upper surface in the illustrated embodiment. A hose or conduit member or the like for communication with the raw water supply unit 20 may be coupled to the inlet boss part 131.

An inlet part 121 is formed inside the inlet boss part 131. Since the inlet part 121 and the inlet boss part 131 extend along the same direction, the inlet part 121 may be said to be a hollow formed through the inlet boss part 131 in the direction in which it extends.

The outlet boss part 132 extends to surround the other one of the housing openings 120, the outlet part 122 in the illustrated embodiment. The outlet boss part 132 may be connected to the purified water discharge unit 30, so that the purified water discharge unit 30 and the outlet part 122 may communicate with each other.

The outlet boss part 132 is formed to extend outward from the one surface of the housing 100, the upper surface in the illustrated embodiment. A hose or conduit member or the like for communication with the purified water discharge unit 30 may be coupled to the outlet boss part 132.

An outlet part 122 is formed inside the outlet boss part 132. Since the outlet part 122 and the outlet boss part 132 extend along the same direction, the outlet part 122 may be said to be a hollow formed through the outlet boss part 132 in the direction in which it extends.

The inlet boss part 131 and the outlet boss part 132 are arranged to be spaced apart from each other. That is, the inlet boss part 131 and the outlet boss part 132 are physically separated so that the inlet part 121 and the outlet part 122 formed through them do not communicate with each other.

In the illustrated embodiment, the inner diameter of the inlet boss part 131 is formed to be smaller than the inner diameter of the outlet boss part 132, but the size relationship may be changed.

The cover unit 200 is coupled to the filter unit 300 to prevent arbitrary fluctuations of the filter unit 300. The filter unit 300 coupled to the cover unit 200 can be stably maintained in a preset position.

The cover unit 200 is accommodated in the housing 100. Specifically, the cover unit 200 is accommodated in the accommodation space 110. In this case, the cover unit 200 may be arranged to be spaced apart from the inner surface of the housing 100 by a predetermined distance.

That is, in the embodiment illustrated in FIG. 4, each surface of the cover unit 200 in the upper, lower, and outer circumferential directions is arranged to be spaced apart from the inner surface of the housing 100. Accordingly, raw water introduced from the raw water supply unit 20 may flow in a space formed between each surface of the cover unit 200 and the inner surface of the housing 100.

The cover unit 200 is coupled to the housing 100. The cover unit 200 does not fluctuate arbitrarily in the accommodation space 110. In the embodiment illustrated in FIG. 4, the cover unit 200 is coupled to the upper side and the lower side of the housing 100, respectively.

The cover unit 200 is coupled to the filter unit 300. As described above, the filter assembly 10 according to an exemplary embodiment of the present invention includes at least two different filtering parts. The cover unit 200 may be coupled to at least two different filtering parts, respectively, to support at least two different filtering parts.

A plurality of cover units 200 may be provided. The plurality of cover units 200 may be coupled to the housing 100 and the filter unit 300 at different positions, respectively. In the illustrated embodiment, the cover unit 200 includes a first cover 210 located at the upper side of the accommodation space 110 and a second cover 220 located at the lower side of the accommodation space 110.

The first cover 210 is coupled to one end of the filter unit 300 and supports each component of the filter unit 300. In the illustrated embodiment, the first cover 210 is coupled to the upper end of the filter unit 300.

The first cover 210 is coupled to an inner surface of one side of the housing 100. Thus, the first cover 210 may be said to combine the inner surface of one side of the housing 100 and the one end of the filter unit 300. In the illustrated embodiment, the first cover 210 is coupled to the upper inner surface of the housing 100.

The first cover 210 communicates with the outside. A cover through hole 214 to be described later is formed inside the first cover 210 to communicate with an external purified water discharge unit 30.

The first cover 210 communicates with the inside of the filter unit 300. The cover through hole 214 formed inside the first cover 210 communicates with a discharge hollow part 340 of the filter unit 300 to be described later.

The first cover 210 is arranged to be spaced apart from the inner surface of the housing 100, i.e., the upper inner surface and the inner surface in the outer circumferential direction in the illustrated embodiment. The introduced raw water may flow in a space formed by separating the first cover 210 and the upper inner surface of the housing 100.

The first cover 210 is formed to surround the outer circumferences of the first filtering part 310 and the second filtering part 320 of the filter unit 300, or is formed to partially surround the outer circumferences. In the illustrated embodiment, the first cover 210 is formed to partially surround each upper side of the outer circumference and inner circumference of the first filtering part 310, and each upper side of the outer circumference and inner circumference of the second filtering part 320.

The first cover 210 is formed to cover one end of the filter unit 300, i.e., an upper end in the illustrated embodiment. The first cover 210 may be coupled to the filter unit 300 while covering both the first filtering part 310 and the second filtering part 320.

The first cover 210 may be formed in a shape corresponding to the accommodation space 110. In the illustrated embodiment, the accommodation space 110 has a cylindrical shape having a circular cross-section and extending in the up-down direction. Accordingly, the first cover 210 may also be formed to have a circular cross-section, and a thickness in the up-down direction.

In the illustrated embodiment, the first cover 210 includes a first plate part 211, a first outer circumferential part 212, a first inner circumferential part 213, a cover through hole 214, and a cover neck part 215.

The first plate part 211 forms a body of the first cover 210. The first plate part 211 is formed to have a larger cross-sectional area than other components, and is coupled to other components of the first cover 210, respectively. The first plate part 211 supports other components of the first cover 210.

The first plate part 211 may be formed in a shape corresponding to the cross-section of the accommodation space 110. In the illustrated embodiment, the first plate part 211 is formed in a circular plate shape having a circular cross-section, and having a thickness in the up-down direction. The first plate part 211 may have an arbitrary shape coupled to the housing 100 and the filter unit 300 to support the filter unit 300.

The first plate part 211 is continuous with the first outer circumferential part 212, the first inner circumferential part 213, and the cover neck part 215, respectively. In addition, the cover through hole 214 is formed through the inside of the first plate part 211.

The first outer circumferential part 212 supports the filter unit 300 from radially outward. The first outer circumferential part 212 supports a portion of the radially outer side of the filter unit 300, i.e., a portion of the upper side in the illustrated embodiment. In the illustrated embodiment, the first outer circumferential part 212 supports a portion of the upper side of the first filtering part 310 located relatively radially outside.

A member such as a gasket may be disposed between the first outer circumferential part 212 and the portion of the radially outer side of the filter unit 300. The first outer circumferential part 212 and the filter unit 300 may be hermetically coupled by the member.

The first outer circumferential part 212 is continuous with the first plate part 211. Specifically, the first outer circumferential part 212 extends along the outer circumference of the first plate part 211. In addition, the first outer circumferential part 212 is formed to extend from one surface of the first plate part 211, i.e., from the lower surface in the illustrated embodiment, in a direction toward the accommodation space 110, i.e., downward in the illustrated embodiment.

That is, the first outer circumferential part 212 extends along the outer circumference of the first plate part 211 from the outside radially with respect to the center of the first plate part 211 and is formed in a ring shape having a predetermined height. In an embodiment, the outer circumferential surface of the first outer circumferential part 212 and the outer circumferential surface of the first plate part 211 may be disposed on the same curved surface.

The first inner circumferential part 213 is located radially inside the first outer circumferential part 212.

The first inner circumferential part 213 supports the filter unit 300 inside. Specifically, the first inner circumferential part 213 is located between the first filtering part 310 located radially outside and the second filtering part 320 located radially inside among the filter unit 300 and supports at least one of the first filtering part 310 and the second filtering part 320.

In the embodiment illustrated in FIG. 4, the first inner circumferential part 213 is disposed to support a portion of the radial outer side of the second filtering part 320 located relatively radially inside, i.e., a portion of the upper side in the illustrated embodiment. Alternatively, the first inner circumferential part 213 may be configured to have an increased thickness to support both the radial inner side of the first filtering part 310 and the radial outer side of the second filtering part 320.

The first inner circumferential part 213 is continuous with the first plate part 211. Specifically, the first inner circumferential part 213 extends in the outer circumferential direction of the first plate part 211 inside the first plate part 211. In addition, the first inner circumferential part 213 is formed to extend from the one surface of the first plate part 211, i.e., from the lower surface in the illustrated embodiment, in a direction toward the accommodation space 110, i.e., downward in the illustrated embodiment.

The first inner circumferential part 213 and the first outer circumferential part 212 may extend downward by the same length. In the above embodiment, the first filtering part 310 located between the first inner circumferential part 213 and the first outer circumferential part 212 is not tilted radially inward or outward, so that it may be more stably supported.

That is, the first inner circumferential part 213 extends in the outer circumferential direction of the first plate part 211 from the outside radially with respect to the center of the first plate part 211 and is formed in a ring shape having a predetermined height. In this case, the first plate part 211, the first outer circumferential part 212, and the first inner circumferential part 213 may be formed to have the same central axis in each cross-section. In other words, the first plate part 211, the first outer circumferential part 212, and the first inner circumferential part 213 may be formed to have a coaxial center.

The first inner circumferential part 213 is spaced apart from the first outer circumferential part 212. The first inner circumferential part 213 located radially inside the first outer circumferential part 212. The upper side of the first filtering part 310 of the filter unit 300 may be partially accommodated in a space formed by separating the first inner circumferential part 213 and the first outer circumferential part 212.

A space surrounded by the inner circumferential surface of the first inner circumferential part 213 and the first plate part 211 is formed inside the first inner circumferential part 213. The upper side of the second filtering part 320 located relatively radially inside is partially accommodated in the space.

That is, the first outer circumferential part 212 and the first inner circumferential part 213 divide the space covered by the first plate part 211 into a plurality of spaces. The first filtering part 310 may be accommodated in one of the plurality of divided spaces, and the second filtering part 320 may be accommodated in the other one. The first filtering part 310 and the second filtering part 320 accommodated in each space may be supported by any one or more of the first plate part 211, the first outer circumferential part 212, and the first inner circumferential part 213.

The cover through hole 214 is formed through the inside of the first plate part 211.

The cover through hole 214 is a passage through which second purified water formed by the filter unit 300 flows toward the outside. The cover through hole 214 communicates the discharge hollow part 340 of the filter unit 300 with the housing opening 120.

The cover through hole 214 is formed through the inside of the first plate part 211. In the embodiment illustrated in FIG. 4, the cover through hole 214 extends in the thickness direction of the first plate part 211.

One end of the cover through hole 214 in the extension direction, i.e., the upper end in the illustrated embodiment, communicates with the outlet part 122 of the housing opening 120. The other end of the cover through hole 214 in the extension direction, i.e., the lower end in the illustrated embodiment, communicates with the discharge hollow part 340 of the filter unit 300.

The cover through hole 214 may have any shape capable of communicating the housing opening 120 with the discharge hollow part 340. In the illustrated embodiment, the cover through hole 214 has a cylindrical shape having a circular cross-section and extending in the up-down direction.

In the above embodiment, the center of the cover through hole 214 may be the same as the center of the first plate part 211.

The cross-section of the cover through hole 214 may be formed to have a predetermined diameter. In an embodiment, the diameter of the cross-section of the cover through hole 214 may be the same as the diameter of the cross-section of the discharge hollow part 340.

The cover through hole 214 is surrounded by the first plate part 211 and the cover neck part 215, respectively.

The cover neck part 215 is a part in which the first cover 210 is connected to the purified water discharge unit 30. The cover neck part 215 extends outward from the other surface of the first plate part 211, i.e., from the upper surface in the illustrated embodiment.

A hollow is formed inside the cover neck part 215. The hollow may be defined as the cover through hole 214 described above. That is, the cover through hole 214 is formed through the first plate part 211 and the cover neck part 215, respectively.

The cover neck part 215 may have an arbitrary shape communicating with the purified water discharge unit 30. In the illustrated embodiment, the cover neck part 215 has a cylindrical shape having a circular cross-section and having a height in the up-down direction.

In the above embodiment, the cover neck part 215 may be disposed to have the same center as the cover through hole 214. That is, each component of the first cover 210 may be formed to be homocentric with each other.

The cover neck part 215 located radially inside the first inner circumferential part 213. That is, the first outer circumferential part 212, the first inner circumferential part 213, the cover neck part 215, and the cover through hole 214 are arranged in a direction from the radially outer side of the first cover 210 toward the center.

The cover neck part 215 may be partially accommodated in the outlet part 122 of the housing opening 120. A sealing member such as a gasket may be provided between the inner surface of the outlet boss part 132 surrounding the outlet part 122 and the outer surface of the cover neck part 215. Accordingly, the first cover 210 and the housing 100 may be stably coupled to each other.

The second cover 220 is coupled to the other end of the filter unit 300 and supports each component of the filter unit 300. In the illustrated embodiment, the second cover 220 is coupled to the lower end of the filter unit 300.

The second cover 220 is coupled to an inner surface of the other side of the housing 100. Thus, the second cover 220 may be said to combine the inner surface of the other side of the housing 100 and the other end of the filter unit 300. In the illustrated embodiment, the second cover 220 is coupled to the lower inner surface of the housing 100.

The second cover 220 is coupled to the filter unit 300. The second cover 220 seals the discharge hollow part 340 formed inside the filter unit 300 and is coupled to the filter unit 300. This is achieved by a cover boss part 224 to be described later.

The second cover 220 is arranged to be spaced apart from the inner surface of the housing 100, i.e., the lower inner surface and the inner surface in the outer circumferential direction in the illustrated embodiment. The introduced raw water may flow in a space formed by separating the second cover 220 and the lower inner surface of the housing 100.

The second cover 220 is formed to surround the outer circumferences of the first filtering part 310 and the second filtering part 320 of the filter unit 300, or is formed to partially surround the outer circumferences. In the illustrated embodiment, the second cover 220 is formed to partially surround each lower side of the outer circumference and inner circumference of the first filtering part 310, and each lower side of the outer circumference and inner circumference of the second filtering part 320.

The second cover 220 is formed to cover the other end of the filter unit 300, i.e., a lower end in the illustrated embodiment. The second cover 220 may be coupled to the filter unit 300 while covering both the first filtering part 310 and the second filtering part 320.

The second cover 220 may be formed in a shape corresponding to the accommodation space 110. In the illustrated embodiment, the accommodation space 110 has a cylindrical shape having a circular cross-section and extending in the up-down direction. Accordingly, the second cover 220 may also be formed to have a circular cross-section, and a thickness in the up-down direction.

In the illustrated embodiment, the second cover 220 includes a second plate part 221, a second outer circumferential part 222, a second inner circumferential part 223, and a cover boss part 224.

The second plate part 221 forms a body of the second cover 220. The second plate part 221 is formed to have a larger cross-sectional area than other components, and is coupled to other components of the second cover 220, respectively. The second plate part 221 supports other components of the second cover 220.

The second plate part 221 may be formed in a shape corresponding to the cross-section of the accommodation space 110. In the illustrated embodiment, the second plate part 221 is formed in a circular plate shape having a circular cross-section, and having a thickness in the up-down direction. The second plate part 221 may have an arbitrary shape coupled to the housing 100 and the filter unit 300 to support the filter unit 300.

The second plate part 221 is continuous with the second outer circumferential part 222, the second inner circumferential part 223, and the cover boss part 224, respectively.

The second outer circumferential part 222 supports the filter unit 300 from radially outward. The second outer circumferential part 222 supports a portion of the radially outer side of the filter unit 300, i.e., a portion of the lower side in the illustrated embodiment. In the illustrated embodiment, the second outer circumferential part 222 supports a portion of the lower side of the first filtering part 310 located relatively radially outside.

A member such as a gasket may be disposed between the second outer circumferential part 222 and the portion of the radially outer side of the filter unit 300. The second outer circumferential part 222 and the filter unit 300 may be hermetically coupled by the member.

The second outer circumferential part 222 is continuous with the second plate part 221. Specifically, the second outer circumferential part 222 extends along the outer circumference of the second plate part 221. In addition, the second outer circumferential part 222 is formed to extend from one surface of the second plate part 221, i.e., from the upper surface in the illustrated embodiment, in a direction toward the accommodation space 110, i.e., upward in the illustrated embodiment.

That is, the second outer circumferential part 222 extends along the outer circumference of the second plate part 221 from the outside radially with respect to the center of the second plate part 221 and is formed in a ring shape having a predetermined height. In an embodiment, the outer circumferential surface of the second outer circumferential part 222 and the outer circumferential surface of the second plate part 221 may be disposed on the same curved surface.

The second inner circumferential part 223 is located radially inside the second outer circumferential part 222.

The second inner circumferential part 223 supports the filter unit 300 inside. Specifically, the second inner circumferential part 223 is located between the first filtering part 310 located radially outside and the second filtering part 320 located radially inside among the filter unit 300 and supports at least one of the first filtering part 310 and the second filtering part 320.

In the embodiment illustrated in FIG. 4, the second inner circumferential part 223 is disposed to support a portion of the radial outer side of the second filtering part 320 located relatively radially inside, i.e., a portion of the lower side in the illustrated embodiment. Alternatively, the second inner circumferential part 223 may be configured to have an increased thickness to support both the radial inner side of the first filtering part 310 and the radial outer side of the second filtering part 320.

The second inner circumferential part 223 is continuous with the second plate part 221. Specifically, the second inner circumferential part 223 extends in the outer circumferential direction of the second plate part 221 inside the second plate part 221. In addition, the second inner circumferential part 223 is formed to extend from the one surface of the second plate part 221, i.e., from the upper surface in the illustrated embodiment, in a direction toward the accommodation space 110, i.e., upward in the illustrated embodiment.

The second inner circumferential part 223 and the second outer circumferential part 222 may extend upward by the same length. In the above embodiment, the first filtering part 310 located between the second inner circumferential part 223 and the second outer circumferential part 222 is not tilted radially inward or outward, so that it may be more stably supported.

That is, the second inner circumferential part 223 extends in the outer circumferential direction of the second plate part 221 from the outside radially with respect to the center of the second plate part 221 and is formed in a ring shape having a predetermined height. In this case, the second plate part 221, the second outer circumferential part 222, and the second inner circumferential part 223 may be formed to have the same central axis in each cross-section. In other words, the second plate part 221, the second outer circumferential part 222, and the second inner circumferential part 223 may be formed to have a coaxial center.

The second inner circumferential part 223 is spaced apart from the second outer circumferential part 222. The second inner circumferential part 223 located radially inside the second outer circumferential part 222. The lower side of the first filtering part 310 of the filter unit 300 may be partially accommodated in a space formed by separating the second inner circumferential part 223 and the second outer circumferential part 222.

A space surrounded by the inner circumferential surface of the second inner circumferential part 223 and the second plate part 221 is formed inside the second inner circumferential part 223. The lower side of the second filtering part 320 located relatively radially inside is partially accommodated in the space.

That is, the second outer circumferential part 222 and the second inner circumferential part 223 divide the space covered by the second plate part 221 into a plurality of spaces. The first filtering part 310 may be accommodated in one of the plurality of divided spaces, and the second filtering part 320 may be accommodated in the other one. The first filtering part 310 and the second filtering part 320 accommodated in each space may be supported by any one or more of the second plate part 221, the second outer circumferential part 222, and the second inner circumferential part 223.

The cover boss part 224 is a part in which the second cover 220 is coupled to the filter unit 300. The cover boss part 224 extends from the one surface of the second plate part 221, i.e., the upper surface in the illustrated embodiment toward the filter unit 300. The cover boss part 224 is inserted into and coupled to one end of the discharge hollow part 340 facing the second cover 220, i.e., the lower end in the illustrated embodiment.

Accordingly, the upper side of the discharge hollow part 340 is formed to be open, and the lower side thereof is closed by the cover boss part 224. As a result, only the filtered second purified water may enter and flow while passing through the first filtering part 310 and the second filtering part 320 in the discharge hollow part 340.

The cover boss part 224 may have a circular cross-section having a predetermined diameter and may be formed to protrude toward the filter unit 300. In this case, the shape of the cross-section of the cover boss part 224 may be determined to correspond to the shape of the discharge hollow part 340.

In the illustrated embodiment, since the discharge hollow part 340 is formed to have a circular cross-section, the cover boss part 224 may also be formed to have a circular cross-section with a predetermined diameter. In the above embodiment, the diameter of the cross-section of the cover boss part 224 is formed to be equal to or greater than the diameter of the cross-section of the discharge hollow part 340, so that the cover boss part 224 may be fitted into the discharge hollow part 340.

The cover boss part 224 inserted into the discharge hollow part 340 may partially support the second filtering part 320. In the illustrated embodiment, it supports the inner circumferential portion of the lower side of the second filtering part 320.

Therefore, the outer circumference of the lower side of the second filtering part 320 is supported by the second inner circumferential part 223, and the inner circumference of the lower side thereof is supported by the cover boss part 224. As a result, the coupling state between the cover unit 200 and the filter unit 300 may be stably maintained.

The filter unit 300 filters raw water flowing into the accommodation space 110 of the housing 100 into first purified water and second purified water. In particular, the filter unit 300 may include a plurality of filtering parts to filter introduced raw water multiple times in different ways to generate purified water.

The filter unit 300 extends in the extension direction of the housing 100, i.e., in the up-down direction in the illustrated embodiment. In addition, the filter unit 300 is formed to have a shape corresponding to the cross-section of the housing 100, i.e., a circular cross-section in the illustrated embodiment. That is, in the illustrated embodiment, the filter unit 300 is formed in a cylindrical shape.

The shape of the filter unit 300 may be changed to any shape capable of generating purified water by filtering introduced raw water by being accommodated in the accommodation space 110 of the housing 100.

The filter unit 300 is accommodated in the accommodation space 110 of the housing 100. As the accommodation space 110 communicates with the outside, raw water to be filtered by the filter unit 300 may be introduced. In addition, the purified water generated by the filter unit 300 may be discharged to the outside.

The filter unit 300 is coupled to the cover unit 200. The filter unit 300 may be coupled to the cover unit 200 at a plurality of positions. As described above, a plurality of cover units 200 according to the illustrated embodiment are provided, including a first cover 210 and a second cover 220. The filter unit 300 may be coupled to the first cover 210 and the second cover 220 at different positions, respectively.

In the illustrated embodiment, the upper end of the filter unit 300 is coupled to the first cover 210. In addition, the lower end of the filter unit 300 is coupled to the second cover 220. Therefore, it may be said that each end of the filter unit 300 in the extension direction is coupled to the cover unit 200.

The filter unit 300 is coupled to the housing 100. Specifically, as the filter unit 300 is coupled to the cover unit 200, and the cover unit 200 is coupled to the housing 100, the filter unit 300 is coupled to the housing 100. That is, the filter unit 300 is coupled to the housing 100 via the cover unit 200.

Therefore, the filter unit 300 accommodated in the accommodation space 110 may be maintained in a state coupled to the cover unit 200 and the housing 100 regardless of the inflow of raw water and the discharge of purified water.

The raw water introduced into the accommodation space 110 may pass through the filter unit 300 through various paths and be filtered. In the illustrated embodiment, the filter unit 300 is configured to filter raw water during the raw water flows radially from the radially outer side of the filter unit 300 toward the radially inner side.

In the illustrated embodiment, the filter unit 300 includes a first filtering part 310, a second filtering part 320, an inlet communication part 330, and a discharge hollow part 340.

The first filtering part 310 filters raw water introduced into the accommodation space 110 to generate first purified water. The generated first purified water is further filtered by the second filtering part 320 and generated into second purified water. Therefore, it can be said that the first filtering part 310 primarily filters raw water.

The first filtering part 310 is coupled to the housing 100. Specifically, the first filtering part 310 is coupled to the housing 100 via the cover unit 200.

The first filtering part 310 may be formed to extend in a direction in which the housing 100 extends, i.e., in the up-down direction in the illustrated embodiment. Each end in a direction in which the first filtering part 310 extends may be coupled to and supported by the cover unit 200. In the illustrated embodiment, the upper end of the first filtering part 310 is coupled to the first cover 210, and the lower end of the first filtering part 310 is coupled to the second cover 220.

The first filtering part 310 may be provided in an arbitrary form capable of generating first purified water by filtering introduced raw water. In an embodiment, the first filtering part 310 may be provided as a hollow fiber membrane filter.

In an embodiment in which the first filtering part 310 is provided as a hollow fiber membrane filter, a plurality of strips 311 constituting the first filtering part 310 may be provided. In the above embodiment, the plurality of strips 311 may be arranged to prevent twisting from each other. This will be described later in detail.

The first filtering part 310 may have an arbitrary shape capable of filtering raw water by being accommodated in the accommodation space 110. In the illustrated embodiment, the first filtering part 310 is formed in a ring shape having a circular cross-section and having a hollow therein.

The outer circumference of each end of the first filtering part 310 is surrounded and supported by the first outer circumferential part 212 and the second outer circumferential part 222 of the cover unit 200. The inner circumference of each end of the first filtering part 310 may be surrounded and supported by the first inner circumferential part 213 and the second inner circumferential part 223 of the cover unit 200. That is, each end of the first filtering part 310 is accommodated in a space between the first outer circumferential part 212 and the first inner circumferential part 213 and in a space between the second outer circumferential part 222 and the second inner circumferential part 223 of the cover unit 200.

In this case, any one end of each end of the first filtering part 310 may be arranged to be spaced apart from the cover unit 200. In addition, the other end of each end of the first filtering part 310 may be arranged in close contact with the cover unit 200. In the illustrated embodiment, the upper end of the first filtering part 310 is arranged to be spaced apart from the first cover 210. In addition, the lower end of the first filtering part 310 is arranged to be spaced apart from the second cover 220.

Therefore, a space for allowing the filtered first purified water to flow toward the second filtering part 320 may be formed between the first filtering part 310 and the first cover 210. The first purified water generated as raw water flows inside the first filtering part 310 may be discharged to the outside of the first filtering part 310 through the space. To this end, the upper end of the first filtering part 310 may be formed open.

The second filtering part 320 is accommodated in the hollow of the first filtering part 310. That is, the first filtering part 310 is arranged to surround the second filtering part 320 from radially outward. In this case, the inner circumferential surface of the first filtering part 310 surrounding the hollow and the outer circumferential surface of the second filtering part 320 may be spaced apart from each other to form a space for the first purified water to flow.

The inlet communication part 330 may be formed in the first filtering part 310. The purified water introduced into the accommodation space 110 may enter the inside of the first filtering part 310 through the inlet communication part 330. The entered raw water may flow along the first filtering part 310 and be filtered, and then enter the space between the first filtering part 310 and the second filtering part 320.

In the illustrated embodiment, the first filtering part 310 includes a strip 311 and a first membrane member 312.

The strip 311 is provided inside the first filtering part 310 to form a path through which the introduced raw water flows. That is, raw water flowing into the first filtering part 310 may flow along the strip 311 and be filtered. A hollow may be formed inside the strip 311 to form a space for the raw water to flow.

The strip 311 may be formed to extend in a direction in which the filter unit 300 extends, i.e., in the up-down direction in the illustrated embodiment. In this case, the strip 311 may extend longer than the extension length of the filter unit 300. Thus, the strip 311 may include at least one curved portion.

A plurality of through holes are formed on the surface, i.e., the outer circumferential surface, of the strip 311. In addition, inside the strip 311, a hollow is formed through the strip 311 in the longitudinal direction and communicates with the outside through the plurality of through holes. Raw water entering the inside of the first filtering part 310 may be introduced into the hollow through the plurality of through holes and filtered into first purified water.

The first purified water flows inside the hollow along the extension direction of the strip 311 and flows toward a first end 311a or a second end 311b. The first purified water may be discharged to the outside through the first end 311a or the second end 311b. To this end, the hollow formed inside the strip 311 extends between the first end 311a and the second end 311b, and each end thereof is formed open to communicate with the outside.

A plurality of strips 311 may be provided. The plurality of strips 311 may be arranged to overlap within the first filtering part 310. In this case, the plurality of strips 311 are arranged alternately from each other, so that entanglement or twisting between the plurality of strips 311 can be prevented. This will be described later in detail.

In the illustrated embodiment, the strip 311 includes a first end 311a, a second end 311b, and a curved portion 311c.

The first end 311a and the second end 311b forms an end of the strip 311 in the extension direction, respectively. The first end 311a and the second end 311b may be coupled to at least one end of each end in the extension direction of the first filtering part 310.

The first end 311a and the second end 311b are continuous with each other. The strip 311 may extend between the first end 311a and the second end 311b. As described above, since the strip 311 extends longer than the filter unit 300, the curved portion 311c is formed between the first end 311a and the second end 311b.

The first end 311a and the second end 311b may be placed at the same location. In addition, the curved portion 311c may be placed in a different position from the first end 311a and the second end 311b.

In the illustrated embodiment, the first end 311a and the second end 311b are arranged adjacent to the upper end of the first filtering part 310. In addition, the curved portion 311c is located adjacent to the lower end of the first filtering part 310.

Therefore, it will be understood that the strip 311 extends downward from any one end of the first end 311a and the second end 311b located at the upper end and then extends again upward from the curved portion 311c toward the other end of the first end 311a and the second end 311b.

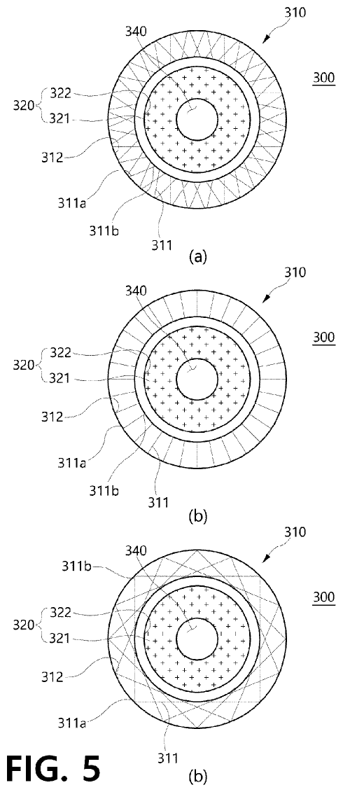

Referring to FIG. 5, various arrangement methods of the first end 311a and the second end 311b are illustrated.

Referring to FIG. 5(a), any one end of the first end 311a and the second end 311b is located adjacent to the outer circumferential surface of the first filtering part 310. The other end of the first end 311a and the second end 311b is located adjacent to the inner circumferential surface of the first filtering part 310. In the illustrated embodiment, the first end 311a is located adjacent to the outer circumferential surface of the first filtering part 310, and the second end 311b is located adjacent to the inner circumferential surface of the first filtering part 310.

In this case, it will be understood that each strip 311 may be disposed to partially overlap each other.

Referring to FIG. 5(b), the first end 311a and the second end 311b are arranged in the manner according to the above-described embodiment. However, in this case, each strip 311 extends from a horizontal direction to a radial direction, and adjacent strips 311 are arranged to be spaced apart from each other. That is, in the present embodiment, a plurality of strips 311 are arranged to be spaced apart from each other.

Referring to FIG. 5(c), each strip 311 is arranged to partially overlap each other. That is, both the first end 311a and the second end 311b are located adjacent to the outer circumferential surface of the first filtering part 310, but a portion extending between the first end 311a and the second end 311b is located adjacent to the inner circumferential surface of the first filtering part 310.

By the above arrangement method, the raw water introduced into the first filtering part 310 may flow along any one of the plurality of strips 311 and be filtered. In addition, the plurality of strips 311 may be arranged in various shapes to prevent entanglement or twisting between them.

The first membrane member 312 forms an outer circumferential surface of the first filtering part 310. The first membrane member 312 is formed to surround a plurality of strips 311 constituting the first filtering part 310 from radially outward.

The first membrane member 312 may be formed of an impermeable material. That is, raw water introduced into the accommodation space 110 cannot pass through the first membrane member 312. Therefore, the introduced raw water can enter the interior of the first filtering part 310 only through the discharge hollow part 340.

The first membrane member 312 prevents arbitrary exposure of the plurality of strips 311. That is, the plurality of strips 311 are surrounded by the first membrane member 312 and are not arbitrarily exposed to the accommodation space 110.

In addition, a membrane member (reference numeral not indicated) surrounding the inner circumferential surface of the first filtering part 310 may be provided. The membrane member may also be formed of an impermeable material like the first membrane member 312.

Thus, the raw water introduced in through the inlet communication part 330 may flow along the strip 311, be filtered, and then be discharged through the upper end of the first filtering part 310. As a result, raw water (i.e., filtered as first purified water) inside the first filtering part 310 can be discharged to the outside only after passing through the first end 311a or the second end 311b.

Accordingly, the flow path of the raw water and the first purified water may be formed according to a preset state.

The second filtering part 320 additionally filters the first purified water filtered by the first filtering part 310 to generate second purified water. The generated second purified water may be discharged to the purified water discharge unit 30 through the discharge hollow part 340. Therefore, it can be said that the second filtering part 320 secondarily filters raw water.

The second filtering part 320 is coupled to the housing 100. Specifically, the second filtering part 320 is coupled to the housing 100 via the cover unit 200.

The second filtering part 320 may be formed to extend in a direction in which the housing 100 extends, i.e., in the up-down direction in the illustrated embodiment. Each end in a direction in which the second filtering part 320 extends may be coupled to and supported by the cover unit 200. In the illustrated embodiment, the upper end of the second filtering part 320 is coupled to the first cover 210, and the lower end of the second filtering part 320 is coupled to the second cover 220.

The second filtering part 320 may be provided in an arbitrary form capable of generating second purified water by filtering introduced raw water. In an embodiment, the second filtering part 320 may be provided as a carbon filter, an ion exchange filter, an anti-scale filter, or another hollow fiber membrane filter.

In an embodiment in which the second filtering part 320 is provided as another hollow fiber membrane filter, the size of the hollow formed inside the strip constituting the second filtering part 320 may be different from the size of the hollow formed inside the strip 311 constituting the first filtering part 310. In addition, it will be understood that a plurality of strips constituting the second filtering part 320 may be provided and arranged to prevent twisting or entanglement between the strips.

The second filtering part 320 may have an arbitrary shape capable of filtering raw water by being accommodated in the accommodation space 110. In the illustrated embodiment the second filtering part 320 is formed in a ring shape having a circular cross-section and having a discharge hollow part 340 therein.

The outer circumference of each end of the second filtering part 320 is surrounded and supported by the first inner circumferential part 213 and the second inner circumferential part 223 of the cover unit 200. Any one end of each end of the second filtering part 320 may be supported by the cover boss part 224. That is, each end of the second filtering part 320 is accommodated in a space surrounded by the first inner circumferential part 213 of the cover unit 200 and in a space between the second inner circumferential part 223 and the cover boss part 224.

In this case, each end of the second filtering part 320 may be placed in close contact with the first cover 210 and the second cover 220, respectively. Therefore, the first purified water flowing into the second filtering part 320 is filtered as second purified water and flows toward the discharge hollow part 340, but does not arbitrarily flow out to other spaces.

The second filtering part 320 is accommodated in a hollow formed inside the first filtering part 310. In this case, the outer circumferential surface of the second filtering part 320 is arranged to be spaced apart from the inner circumferential surface of the first filtering part 310. As described above, first purified water can flow through the space formed by the above arrangement and enter the second filtering part 320.

In the illustrated embodiment, the second filtering part 320 includes a filtering member 321 and a second membrane member 322.

The filtering member 321 substantially performs the role of filtering first purified water to generate second purified water. The filtering member 321 is accommodated in the internal space of the second filtering part 320. The first purified water may pass through the filtering member 321 and be filtered into second purified water. The filtering member 321 may be made of different materials depending on the type of the second filtering part 320.

The filtering member 321 is surrounded by the second membrane member 322.

The second membrane member 322 forms an outer circumferential surface of the second filtering part 320. The second membrane member 322 is formed to surround the filtering member 321 filled inside the second filtering part 320 from radially outward.

The second membrane member 322 is formed of an impermeable material, and a plurality of through holes communicating the accommodation space 110, that is, a space formed between the first filtering part 310 and the second filtering part 320 with the inside of the second filtering part 320 may be formed therein. The first purified water introduced into the space may be introduced into the second filtering part through the through holes.

In addition, a membrane member (reference numeral not indicated) surrounding the inner circumferential surface of the second filtering part 320, that is, a membrane member surrounding the discharge hollow part 340, may be provided. The membrane member may also be formed of an impermeable material like the second membrane member 322, and a plurality of through holes may be formed therein.

Therefore, the first purified water entering the inside of the second filtering part 320 through the through holes formed in the second membrane member 322 may be filtered into second purified water and flow toward the discharge hollow part 340.

The inlet communication part 330 communicates the accommodation space 110 with the inside of the first filtering part 310. Raw water introduced into the accommodation space 110 may pass through the inlet communication part 330 to flow into the inside of the first filtering part 310. The inlet communication part 330 is formed through the first membrane member 312.

A plurality of inlet communication parts 330 may be formed. The plurality of inlet communication parts 330 may be formed at different positions, respectively.

In the illustrated embodiment, the inlet communication part 330 includes a main communication hole 331 and a sub communication hole 332. In this case, the inlet communication part 330 may include a main communication hole 331, and may selectively include a sub communication hole 332.

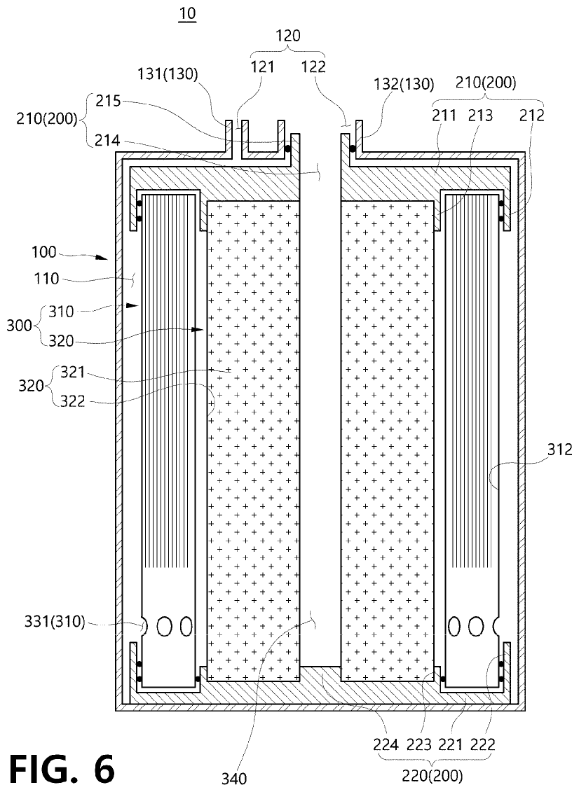

That is, in the embodiments shown in FIGS. 3 to 4 and 7, the inlet communication part 330 may include both the main communication hole 331 and the sub communication hole 332. In the embodiment shown in FIG. 6, the inlet communication part 330 may include only the main communication hole 331.

The main communication hole 331 is located to be biased toward one end of the first filtering part 310 in the extension direction to communicate the accommodation space 110 with the inside of the first filtering part 310. In the illustrated embodiment, the main communication hole 331 is located adjacent to the lower end of the first filtering part 310.

A plurality of main communication holes 331 may be formed. The plurality of main communication holes 331 may be formed to be spaced apart from each other along the outer circumference of the first filtering part 310.

Therefore, in an embodiment in which the main communication hole 331 is formed, raw water introduced into the accommodation space 110 may enter the curved portion 311c located at the lower side, flow along the strip 311, and be filtered.

The sub communication hole 332 is formed adjacent to the main communication hole 331.

The sub communication hole 332 is located in a part of the first filtering part 310 to communicate the accommodation space 110 with the inside of the first filtering part 310. In the illustrated embodiment, the sub communication hole 332 is located between the upper end of the first filtering part 310 and the main communication hole 331.

A plurality of sub communication holes 332 may be formed. The plurality of sub communication holes 332 may be formed to be spaced apart from each other in the extension direction (i.e., the up-down direction in the illustrated embodiment) of the first filtering part 310. The plurality of sub communication holes 332 may be defined as a group of sub communication holes 332.

In addition, the sub communication holes 332 may be provided in multiple groups. The plurality of groups of sub communication holes 332 may be formed to be spaced apart from each other along the outer circumferential direction of the first filtering part 310.

Therefore, in an embodiment in which the sub communication hole 332 is formed, raw water introduced into the accommodation space 110 may enter the inside of the first filtering part 310 through the sub communication hole 332, flow toward the first end 311a or the second end 311b, and be filtered.

The sub communication hole 332 may be formed in various shapes capable of communicating the accommodation space 110 with the inside of the first filtering part 310.

In the embodiments shown in FIGS. 3 and 4, the sub communication hole 332 is formed as a small opening having a circular or elliptical cross-section. In the above embodiment, a plurality of sub communication holes 332 are formed to be spaced apart from each other in the extension direction of the first filtering part 310. In addition, the plurality of sub communication holes 332 may include a plurality of groups formed to be spaced apart from each other along the outer circumference of the first filtering part 310.

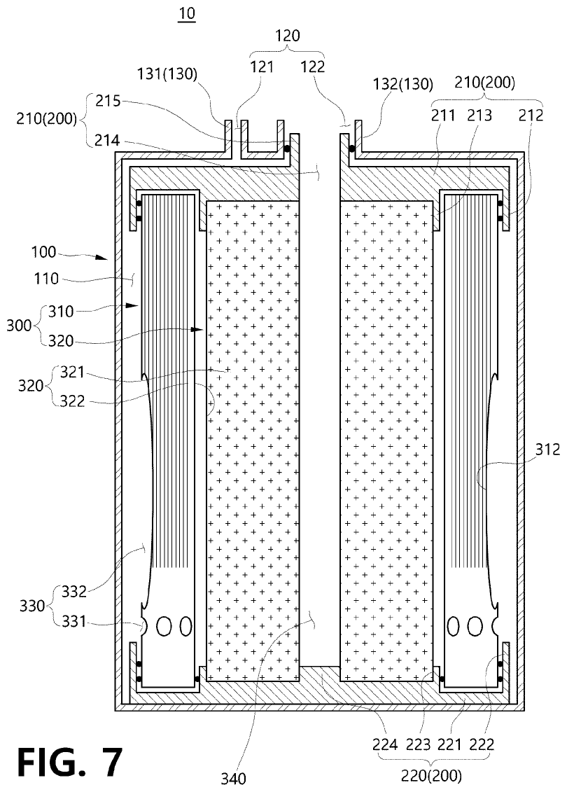

In the embodiment illustrated in FIG. 7, the sub communication hole 332 may be formed as a single opening extending long in the extension direction, i.e., the up-down direction, of the first filtering part 310. In the above embodiment, a plurality of sub communication holes 332 may also be formed to be spaced apart from each other in the extension direction of the first filtering part 310.

A detailed description of the flow process of raw water, first purified water, and second purified water through the inlet communication part 330 will be described later.

The discharge hollow part 340 functions as a passage through which the generated second purified water is discharged to the outside. The discharge hollow part 340 is formed through the inside of the filter unit 300. Specifically, in the illustrated embodiment, the discharge hollow part 340 is formed inside the second filtering part 320, extending in the direction in which the second filtering part 320 extends, i.e., in the up-down direction.

One end of the discharge hollow part 340 in its extension direction may be open, and the other end may be closed. In the illustrated embodiment, the upper end of the discharge hollow part 340 is formed open and communicates with the cover through hole 214 and the outlet part 122. The lower end of the discharge hollow part 340 is closed by inserting and combining the cover boss part 224 thereto.

Therefore, the second purified water, which passed through the second filtering part 320 and entered the discharge hollow part 340, may flow to one open end (the upper end in the illustrated embodiment) and flow out to the purified water discharge unit 30.

The discharge hollow part 340 may have an arbitrary shape capable of guiding the second purified water toward the outlet part 122. In the illustrated embodiment, the discharge hollow part 340 is formed to have a circular cross-section and to extend in the extension direction, i.e., the up-down direction, of the second filtering part 320.

In an embodiment in which the discharge hollow part 340 is formed to have a circular cross-section, the discharge hollow part 340 may be formed to have the same center as the first filtering part 310 and the second filtering part 320. In addition, in the above embodiment, the discharge hollow part 340 may be formed to have the same center as the first cover 210 and the second cover 220.

Each component of the filter unit 300 described above, in particular, the first filtering part 310 and the second filtering part 320 may be provided in the form of a module. That is, the first filtering part 310 and the second filtering part 320 may be independently combined with or separated from other components of the filter unit 300.

Therefore, as the use of the water purifier 1 and the filter assembly 10 continues, among the first filtering part 310 and the second filtering part 320, only the filtering part requiring replacement is removed and replaced, and the filtering part that does not require replacement remains and can be used continuously. Accordingly, the convenience and economy of maintenance of the water purifier can be improved, thereby increasing user satisfaction.

The filter assembly 10 according to an exemplary embodiment of the present invention includes a plurality of filtering parts that filter raw water in different ways to generate purified water. Raw water introduced into the filter assembly 10 may be filtered while passing through one or more of the plurality of filtering parts to produce purified water.

In addition, the filter assembly 10 according to an exemplary embodiment of the present invention is formed by stacking a plurality of filtering parts in the radial direction. Therefore, water purification efficiency can be improved while the size of the space occupied by the plurality of filtering parts is reduced.

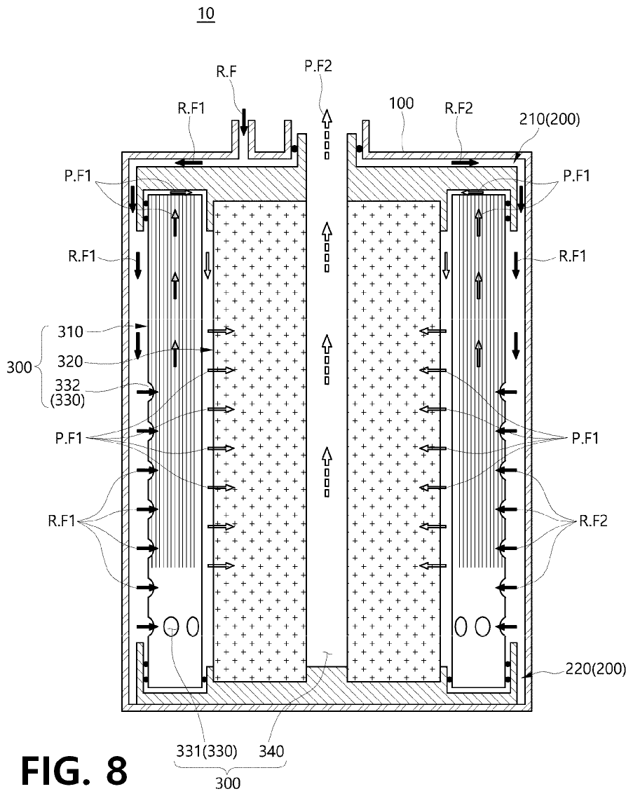

Hereinafter, a flow path formed inside the filter assembly 10 according to an exemplary embodiment of the present invention will be described in detail with reference to FIGS. 8 to 10.

In the illustrated embodiment, a raw water flow path R.F, a first purified water flow path P.F1, and a second purified water flow path P.F2 may be formed inside the filter assembly 10. In this case, the raw water flow path R.F may include a first raw water flow path R.F1 and a second raw water flow path R.F2 branched from the accommodation space 110.

Referring to FIG. 8, the flow path formed inside the filter assembly 10 according to an exemplary embodiment of the present invention will be described in detail.

The accommodation space 110 of the housing 100 communicates with the raw water supply unit 20. The communication is achieved by the inlet part 121 of the housing opening 120. The raw water flow path R.F is formed between the raw water supply unit 20 and the accommodation space 110 by passing through the inlet part 121.

The raw water flow path R.F entered into the accommodation space 110 may be branched into a plurality of flow paths. In the illustrated embodiment, the raw water flow path R.F includes a first raw water flow path R.F1 flowing to the left and a second raw water flow path R.F2 flowing to the right.

The first raw water flow path R.F1 and the second raw water flow path R.F2 flow horizontally along a space formed between the upper inner surface of the housing 100 and the first cover 210. The first raw water flow path R.F1 and the second raw water flow path R.F2 extending to the first outer circumferential part 212 extend toward the second cover 220.

As described above, the outer circumferential surface of the first filtering part 310 forming the radial outer side of the filter unit 300 is surrounded by the first membrane member 312 formed of an impermeable material. Therefore, the first raw water flow path R.F1 and the second raw water flow path R.F2 extend to the point where the inlet communication part 330 is formed.

In the embodiment illustrated in FIG. 8, the inlet communication part 330 includes both a main communication hole 331 positioned biased to the lower side and a sub communication hole 332 positioned above the main communication hole 331. Accordingly, the first raw water flow path R.F1 and the second raw water flow path R.F2 extend to the main communication hole 331 located at a relatively lower side, and some of them are branched toward the sub communication hole 332.

The raw water introduced through the inlet communication part 330 into the first filtering part 310 enters the hollow formed in the strip 311 through a plurality of through holes formed in each of the plurality of strips 311 and is filtered into first purified water. The first purified water introduced into the hollow flows along the strip 311 and flows toward the first end 311a or the second end 311b.

As described above, the filtered first purified water is discharged through the upper end of the open first filtering part 310 and flows into a space formed between the first cover 210 and the upper end of the first filtering part 310.

Accordingly, it will be understood that the first purified water flow path P.F1 extends from the upper end of the first filtering part 310 toward the space.

As described above, the inner circumferential surface of the first filtering part 310 may be formed of an impermeable material. In addition, the second membrane member 322 of the second filtering part 320 may be formed of an impermeable material, and a plurality of through holes may be formed therein. Accordingly, the first purified water flow path P.F1 extends in a direction opposite to the first cover 210, i.e., downward in the illustrated embodiment. In addition, the first purified water flow path P.F1 extends into the inside of the second filtering part 320 through at least one of a plurality of through holes formed in the second membrane member 322 of the second filtering part 320.

The first purified water passes through the second filtering part 320 and is filtered to generate second purified water. Accordingly, the second purified water flow path P.F2 extends from the inside of the second filtering part 320 toward the discharge hollow part 340. One end of the discharge hollow part 340 (the upper end in the illustrated embodiment) is open, and the other end thereof (the lower end in the illustrated embodiment) is closed.

Accordingly, the second purified water flow path P.F2 extends from the inside of the second filtering part 320 through the discharge hollow part 340 to the outlet part 122. By the above process, the second purified water may be delivered to the purified water discharge unit 30.

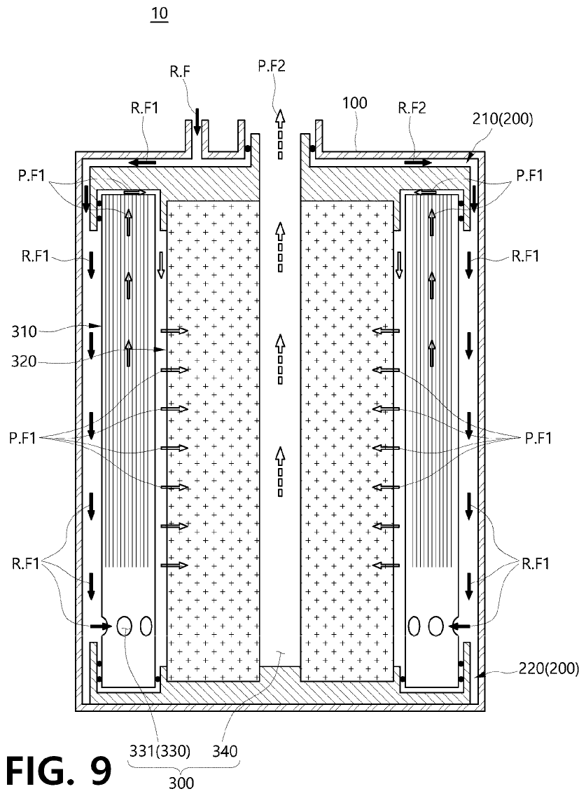

Referring to FIG. 9, the flow path formed inside the filter assembly 10 according to another exemplary embodiment of the present invention will be described in detail.

The filter assembly 10 according to the illustrated embodiment differs in that the accommodation space 110 and the inside of the first filtering part 310 communicate with each other only by the main communication hole 331 without a separate sub communication hole 332.

Accordingly, except for the above difference, the raw water flow path R.F, the first purified water flow path P.F1, and the second purified water flow path P.F2 are the same, and thus, hereinafter, the first raw water flow path R.F1 and the second raw water flow path R.F2 will be mainly described.

The raw water flow path R.F entered into the accommodation space 110 may be branched into a plurality of flow paths. In the illustrated embodiment, the raw water flow path R.F includes a first raw water flow path R.F1 flowing to the left and a second raw water flow path R.F2 flowing to the right.

The first raw water flow path R.F1 and the second raw water flow path R.F2 flow horizontally along a space formed between the upper inner surface of the housing 100 and the first cover 210. The first raw water flow path R.F1 and the second raw water flow path R.F2 extending to the first outer circumferential part 212 extend toward the second cover 220.

As described above, the outer circumferential surface of the first filtering part 310 forming the radial outer side of the filter unit 300 is surrounded by the first membrane member 312 formed of an impermeable material. Therefore, the first raw water flow path R.F1 and the second raw water flow path R.F2 extend to the point where the inlet communication part 330 is formed.

In the present embodiment, the inlet communication part 330 includes only the main communication hole 331 positioned biased to the lower side. Accordingly, the first raw water flow path R.F1 and the second raw water flow path R.F2 extend to the main communication hole 331 located at a relatively lower side.

The raw water introduced through the inlet communication part 330 into the first filtering part 310 enters the hollow formed in the strip 311 through a plurality of through holes formed on the outer circumferential surface of the plurality of strips 311 and is filtered into first purified water. Since the subsequent flow path formation process is the same as the above-described embodiment, redundant description will be omitted below.

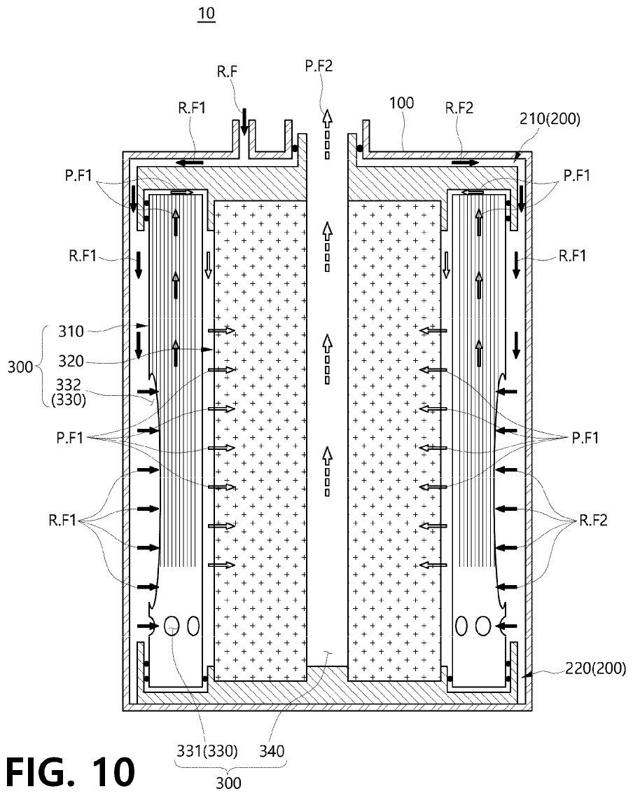

Referring to FIG. 10, the flow path formed inside the filter assembly 10 according to yet another exemplary embodiment of the present invention will be described in detail.

The filter assembly 10 according to the illustrated embodiment differs in that the inlet communication part 330 is formed to include both the main communication hole 331 and the sub communication hole 332, and the sub communication hole 332 is formed to extend in the up-down direction.

Accordingly, except for the above difference, the first purified water flow path P.F1 and the second purified water flow path P.F2 are the same, and thus, hereinafter, the first raw water flow path R.F1 and the second raw water flow path R.F2 will be mainly described.

The raw water flow path R.F entered into the accommodation space 110 may be branched into a plurality of flow paths. In the illustrated embodiment, the raw water flow path R.F includes a first raw water flow path R.F1 flowing to the left and a second raw water flow path R.F2 flowing to the right.

The first raw water flow path R.F1 and the second raw water flow path R.F2 flow horizontally along a space formed between the upper inner surface of the housing 100 and the first cover 210. The first raw water flow path R.F1 and the second raw water flow path R.F2 extending to the first outer circumferential part 212 extend toward the second cover 220.

As described above, the outer circumferential surface of the first filtering part 310 forming the radial outer side of the filter unit 300 is surrounded by the first membrane member 312 formed of an impermeable material. Therefore, the first raw water flow path R.F1 and the second raw water flow path R.F2 extend to the point where the inlet communication part 330 is formed.

In the present embodiment, the sub communication hole 332 of the inlet communication part 330 is formed to extend long in the up-down direction. Accordingly, the first raw water flow path R.F1 and the second raw water flow path R.F2 extend to the main communication hole 331 located at a relatively lower side. In this case, the first raw water flow path R.F1 and the second raw water flow path R.F2 may be branched into a part flowing into the first filtering part 310 through the sub communication hole 332 and another part flowing into the first filtering part 310 through the main communication hole 331.

The raw water introduced through the inlet communication part 330 into the first filtering part 310 enters the hollow formed in the strip 311 through a plurality of through holes formed on the outer circumferential surface of the plurality of strips 311 and is filtered into first purified water. Since the subsequent flow path formation process is the same as the above-described embodiment, redundant description will be omitted below.

### 4. Description of the Filter Assembly 21 According to the Second Embodiment of the Present Invention

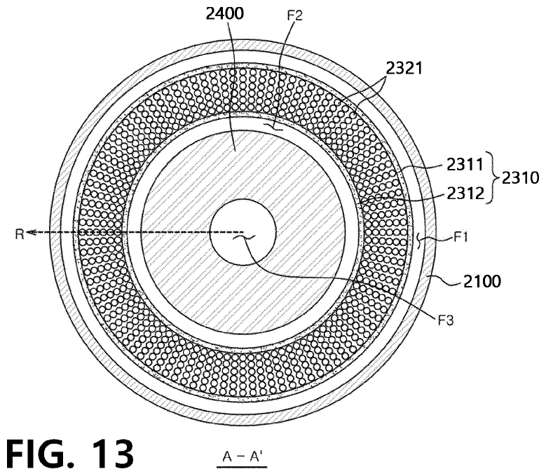

In the following description, the up-down direction may be the up-down direction of FIGS. 1 to 12, and 17, and the radial direction may be the radial direction R of FIG. 13.

Hereinafter, a detailed configuration of the water purifier 1 according to the second embodiment of the present invention will be described with reference to the drawings.

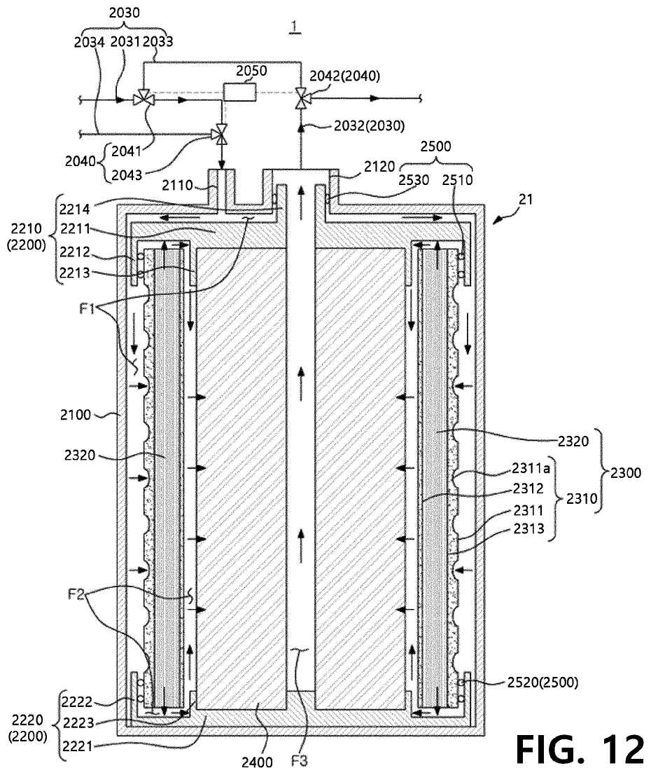

Hereinafter, referring to FIGS. 1 and 12, the water purifier 1 according to the second embodiment of the present invention may provide clean water to a user by filtering water supplied from the outside. For example, the water purifier 1 may receive water from a water supply source (not shown) such as water supply, and may filter the received water into clean water. This water purifier 1 may include a frame 10, a filter assembly 21, a flow path unit 2030, a valve unit 2040, and a control device 2050.

Meanwhile, water introduced into the filter assembly 21 from the outside may be divided into raw water and purified water. Hereinafter, water that has not passed through a first filter 2300 and a second filter 2400 to be described later among water introduced into the water purifier 1 from the outside is defined as raw water, and water filtered through any one of the first filter 2300 and the second filter 2400 is defined as purified water.

The frame 10 may accommodate the filter assembly 21, the flow path unit 2030, the valve unit 2040, and the control device 2050 therein, and may support the filter assembly 21, the flow path unit 2030, the valve unit 2040, and the control device 2050.

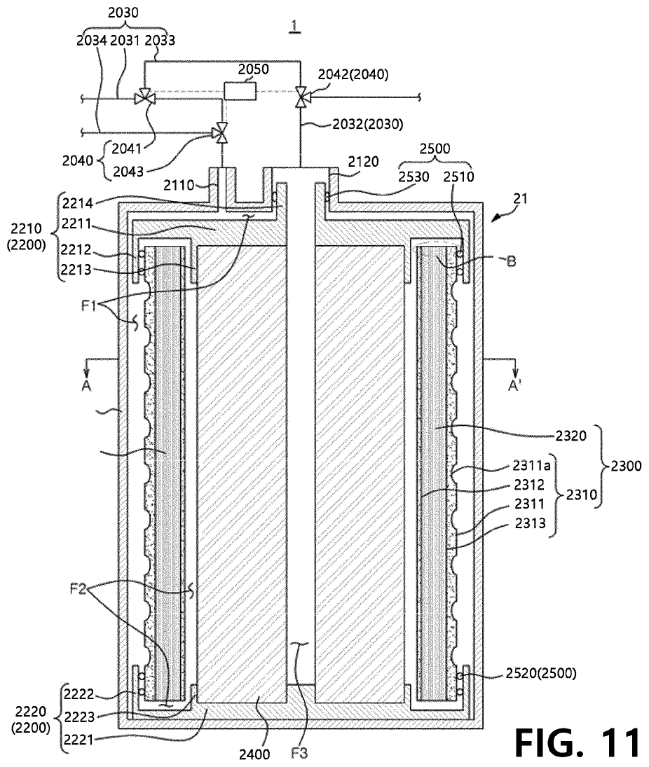

Referring to FIGS. 11 and 12, the filter assembly 21 may filter raw water and provide purified water to a user. The filter assembly 21 may be attached to or detached from the frame 10. For example, if the filter assembly 21 is used for a long time and the filtration performance is deteriorated, it may be replaced with another filter assembly 21. In addition, purified water passing through the filter assembly 21 may be discharged to the outside. The filter assembly 21 may include a housing 2100, a cap 2200, a first filter 2300, a second filter 2400, and a sealing unit 2500.

A space for accommodating the cap 2200, the first filter 2300, the second filter 2400, and the sealing unit 2500 may be formed in the housing 2100, and the cap 2200, the first filter 2300, the second filter 2400, and the sealing unit 2500 may be accommodated in the inner space of the housing 2100. An inlet 2110 through which raw water is introduced and an outlet 2120 for discharging purified water to the outside of the housing 2100 may be formed in the housing 2100. For example, the inlet 2110 and the outlet 2120 may be formed at an upper portion of the housing 2100. In addition, the inlet 2110 may communicate with a water inlet flow path 2031 to be described later, and the outlet 2120 may communicate with a water outlet flow path 2032 to be described later.

The cap 2200 may be disposed inside the housing 2100 to support the first filter 2300, the second filter 2400, and the sealing unit 2500. In addition, the cap 2200 may guide the flow of raw water and purified water so that raw water and purified water flowing inside the housing 2100 flow toward the first filter 2300 and the second filter 2400. The cap 2200 may include an upper cap member 2210 and a lower cap member 2220.

The upper cap member 2210 may be disposed inside the housing 2100, and may be disposed above the lower cap member 2220. The upper cap member 2210 may support upper portions of the first filter 2300 and the second filter 2400. In addition, a raw water flow path F1 through which raw water may flow may be formed between the upper cap member 2210 and the inner surface of the housing 2100. The raw water flow path F1 may provide a passage for raw water introduced through the inlet 2110 into the housing 2100 to flow to the first filter 2300. Here, the raw water flow path F1 may be a concept including a passage between the housing 2100 and the first filter 2300 as well as a passage between the housing 2100 and the upper cap member 2210.

In addition, the upper cap member 2210 may be configured to be spaced apart upward by a predetermined distance from the upper end portion of the first filter 2300. In other words, the inner surface of the upper cap member 2210 may be spaced apart from the upper end of the first filter 2300 in the up-down direction. In addition, a transfer flow path F2 through which purified water passing through the first filter 2300 can flow may be formed between the upper cap member 2210 and the upper end of the first filter 2300. The transfer flow path F2 may provide a passage for purified water passing through the first filter 2300 to flow to the second filter 2400. Here, the transfer flow path F2 may be a concept including a passage between the first filter 2300 and the second filter 2400 as well as a passage between the first filter 2300 and the upper cap member 2210.

The upper cap member 2210 may include an upper cap body part 2211, a first upper cap support part 2212, a second upper cap support part 2213, and an upper cap outlet part 2214.

The upper cap body part 2211 may be in contact with the upper end of the second filter 2400 to support the second filter 2400. The upper cap body part 2211 may be spaced apart upward by a predetermined distance from the upper end of the first filter 2300 to form a part of the transfer flow path F2. In addition, the upper cap body part 2211 may be spaced apart a predetermined distance downward from the inner surface of the housing 2100 to form a part of the raw water flow path F1. A cap hole 2211a for allowing the purified water passing through the second filter 2400 to flow to the outlet 2120 may be formed in the upper cap body part 2211.

The first upper cap support part 2212 may extend downward from the upper cap body part 2211 to support the first filter 2300. For example, the first upper cap support part 2212 may protrude downward from the circumferential surface of the upper cap body part 2211. In addition, the first upper cap support part 2212 may extend to surround the outer circumferential surface of the upper end of the first filter 2300. The first upper cap support part 2212 may be spaced apart from the inner surface of the housing 2100 to form a part of the raw water flow path F1.

The second upper cap support part 2213 may extend downward from the upper cap body part 2211 to support the second filter 2400. For example, the second upper cap support part 2213 may protrude downward from the upper cap body part 2211. In addition, the second upper cap support part 2213 may extend to surround the outer circumferential surface of the upper end of the second filter 2400. The second upper cap support part 2213 may be disposed between the inner circumferential surface of the first filter 2300 and the outer circumferential surface of the second filter 2400. In addition, the second upper cap support part 2213 may be laterally spaced apart from the first filter 2300 so that purified water flowing along the transfer flow path F2 flows between the first filter 2300 and the second filter 2400.

The upper cap outlet part 2214 may provide a passage for discharging purified water flowing inside the cap 2200. The upper cap outlet part 2214 may extend upward from the upper cap body part 2211 and may communicate with the cap hole 2211a. In addition, at least a portion of the upper cap outlet part 2214 may be inserted into the outlet 2120. The purified water may flow to the outlet 2120 by the upper cap outlet part 2214.

The lower cap member 2220 may be disposed inside the housing 2100 and may support lower portions of the first filter 2300 and the second filter 2400. In addition, the lower cap member 2220 may be configured to be spaced downward by a predetermined distance from the lower end portion of the second filter 2400. In addition, a transfer flow path F2 through which purified water can flow may be formed between the lower cap member 2220 and the lower end of the first filter 2300.

The lower cap member 2220 may include a lower cap body part 2221, a first lower cap support part 2222, and a second lower cap support part 2223.

The lower cap body part 2221 may be in contact with the lower end of the second filter 2400 to support the second filter 2400. The lower cap body part 2221 may be spaced apart downward by a predetermined distance from the lower end of the first filter 2300 to form a part of the transfer flow path F2.

The first lower cap support part 2222 may extend upward from the lower cap body part 2221 to support the first filter 2300. For example, the first lower cap support part 2222 may protrude upward from the circumferential surface of the lower cap body part 2221. In addition, the first lower cap support part 2222 may extend to surround the outer circumferential surface of the lower end of the first filter 2300.

The second lower cap support part 2223 may extend upward from the lower cap body part 2221 to support the second filter 2400. For example, the second lower cap support part 2223 may protrude upward from the lower cap body part 2221. In addition, the second lower cap support part 2223 may extend to surround the outer circumferential surface of the lower end of the second filter 2400. The second lower cap support part 2223 may be disposed between the inner circumferential surface of the first filter 2300 and the outer circumferential surface of the second filter 2400. In addition, the second lower cap support part 2223 may be laterally spaced apart from the first filter 2300 so that purified water flowing along the transfer flow path F2 flows between the first filter 2300 and the second filter 2400.

Referring to FIG. 13, the first filter 2300 may be accommodated in the housing 2100 and may filter raw water to provide purified water. In addition, when viewed from the top, the first filter 2300 may be spaced apart from the outside of the second filter 2400 by a predetermined distance and extend in a ring shape to surround at least a portion of the second filter 2400. The first filter 2300 may include a fiber support 2310, a filter member 2320, and a filter holder 2330.

The fiber support 2310 may support the filter member 2320, and may provide an accommodation part 2313, which is a space in which the filter member 2320 may be accommodated. The fiber support 2310 may be supported by the cap 2200 and may extend to surround the second filter 2400 when viewed from the top. In addition, the fiber support 2310 may include a filter outer body 2311 and a filter inner body 2312.

When viewed from the top, the filter outer body 2311 may be spaced apart from the filter inner body 2312 by a predetermined distance, and may extend in a ring shape to surround the filter inner body 2312. The filter outer body 2311 may extend in the up-down direction.

When viewed from the top, the filter inner body 2312 may be spaced apart from the second filter 2400 by a predetermined distance, and may extend in a ring shape to surround the second filter 2400. In addition, the filter inner body 2312 may be disposed between the filter outer body 2311 and the second filter 2400. The filter inner body 2312 may extend in the up-down direction.

Meanwhile, a communication hole 2311a through which raw water flows may be formed in the filter outer body 2311. The communication hole 2311a may be formed through the filter outer body 2311 and may communicate with the accommodation part 2313. In addition, the communication hole 2311a may communicate with the raw water flow path F1. For example, raw water flowing along the raw water flow path F1 may flow toward the accommodation part 2313 through the communication hole 2311a.

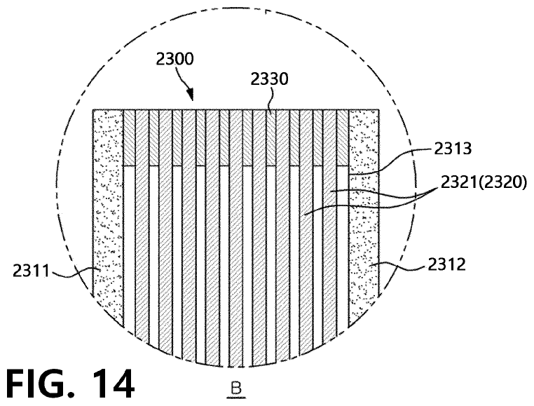

Referring to FIG. 14, the accommodation part 2313 may accommodate the filter member 2320. The accommodation part 2313 is provided by the filter outer body 2311 and the filter inner body 2312, and may include a space formed between the filter outer body 2311 and the filter inner body 2312.

Referring back to FIG. 13, the filter member 2320 may filter raw water to provide purified water. The filter member 2320 may include a plurality of hollow fibers 2321 for filtering raw water. The plurality of hollow fibers 2321 may filter raw water introduced from the communication hole 2311a to provide purified water. In addition, the plurality of hollow fibers 2321 may discharge purified water toward the upper cap body part 2211 and the lower cap body part 2221 so that purified water flows along the transfer flow path F2.

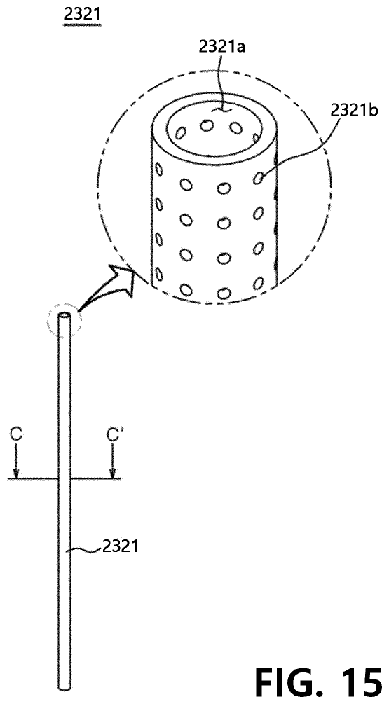

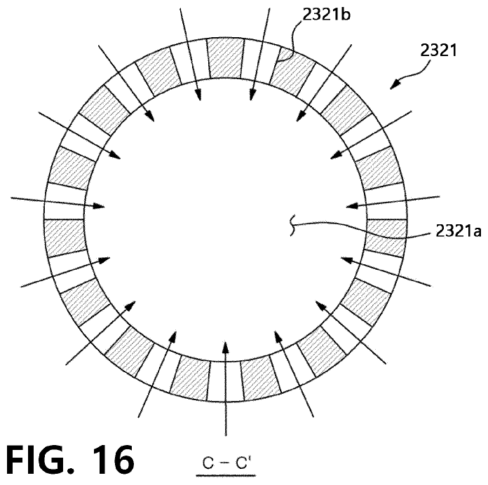

Referring to FIGS. 15 and 16, the hollow fiber 2321 may have a predetermined length, and may extend to have a ‘l’ shape. In addition, a plurality of hollow fibers 2321 are provided, and the plurality of hollow fibers 2321 may be combined with each other by the filter holder 2330. The hollow fiber 2321 may include a fiber passage 2321a and a through hole 2321b.

The fiber passage 2321a may be a passage provided inside the hollow fiber 2321 so that the filtered purified water flows. In other words, the fiber passage 2321a may be a passage that penetrates the central portion of the hollow fiber 2321 and extends in the longitudinal direction of the hollow fiber 2321. The purified water introduced into the fiber passage 2321a may flow in the longitudinal direction of the hollow fiber 2321. In addition, the hollow fiber 2321 may extend so that both ends of the fiber passage 2321a are open toward opposite sides. For example, the hollow fiber 2321 may extend in the up-down direction so that one end of the fiber passage 2321a is open upward, and the other end, which is the opposite end of the one end, is open downward.

The through hole 2321b may communicate with the fiber passage 2321a so that raw water introduced into the fiber support 2310 flows into the fiber passage 2321a. The through hole 2321b is formed through the hollow fiber 2321, and may extend in a direction that deviates from the direction in which the fiber passage 2321a extends. In addition, a plurality of through holes 2321b may be provided, and the plurality of through holes 2321b may be disposed to be spaced apart in the longitudinal direction of the hollow fiber 2321. For example, the size of the through hole 2321b may be 18 nm to 22 nm.

Referring back to FIG. 14, the filter holder 2330 may couple a plurality of hollow fibers 2321 and a fiber support 2310. The plurality of hollow fibers 2321 may be placed in the accommodation part 2313 by the filter holder 2330. For example, the filter holder 2330 may include urethane or the like.

The second filter 2400 may filter purified water. The second filter 2400 may be placed inside the first filter 2300, and may secondly re-filter purified water that has been primarily filtered by the first filter 2300. For example, the second filter 2400 may include a carbon filter. In addition, the second filter 2400 may have a ring shape, and a discharge flow path F3 through which purified water or raw water flows may be formed inside the second filter 2400. The discharge flow path F3 may be provided by the second filter 2400, the cap hole 2211a, the upper cap outlet part 2214, and the inlet 2110.

The sealing unit 2500 may limit the flow of raw water and purified water flowing inside the housing 2100. The sealing unit 2500 may include a first sealing member 2510, a second sealing member 2520, and a third sealing member 2530.

The first sealing member 2510 may seal between the upper cap member 2210 and the first filter 2300. In other words, the first sealing member 2510 may seal between the first upper cap support part 2212 and the filter outer body 2311. For example, the first sealing member 2510 may prevent purified water flowing along the transfer flow path F2 from being introduced between the first filter 2300 and the housing 2100 and mixed with raw water flowing along the raw water flow path F1.

The second sealing member 2520 may seal between the lower cap member 2220 and the first filter 2300. In other words, the second sealing member 2520 may seal between the first lower cap support part 2222 and the filter outer body 2311. For example, it may prevent purified water flowing along the transfer flow path F2 from flowing between the first filter 2300 and the housing 2100 and mixed with raw water flowing along the raw water flow path F1.

The third sealing member 2530 may seal between the housing 2100 and the upper cap member 2210. In other words, the third sealing member 2530 may seal between the outlet 2120 and the upper cap outlet part 2214. For example, the third sealing member 2530 can prevent raw water in the raw water flow path F1 from being discharged to the outside through the outlet 2120.

The flow path unit 2030 may provide a passage through which raw water and purified water flow. The flow path unit 2030 may include a water inlet flow path 2031, a water outlet flow path 2032, a bypass flow path 2033, and a drain flow path 2034.

The water inlet flow path 2031 may provide a passage through which raw water flows to the inlet 2110. For example, the water inlet flow path 2031 may guide the flow of raw water so that the raw water introduced into the water purifier 1 flows toward the inside of the filter assembly 21. The water inlet flow path 2031 may be connected to the inlet 2110 and may communicate with the raw water flow path F1.

In addition, the water inlet flow path 2031 may provide a passage through which purified water flows. For example, the water inlet flow path 2031 may guide the flow of purified water so that purified water sequentially passing through the second filter 2400 and the first filter 2300 flows to the drain flow path 2034 in a backflushing mode to be described later.

The water outlet flow path 2032 may provide a passage through which purified water discharged from the outlet 2120 flows. For example, the water outlet flow path 2032 may guide the flow of purified water so that the purified water sequentially passing through the first filter 2300 and the second filter 2400 flows toward the outside. The water outlet flow path 2032 may be connected to the outlet 2120 and may communicate with the discharge flow path F3.

In addition, the water outlet flow path 2032 may provide a passage through which raw water flows. For example, the water outlet flow path 2032 may guide the flow of raw water so that the raw water introduced through the bypass flow path 2033 flows to the outlet 2120 in the backflushing mode.

The bypass flow path 2033 may provide a passage for raw water to flow, and may communicate the water inlet flow path 2031 with the water outlet flow path 2032. For example, the bypass flow path 2033 may guide the flow of raw water so that the raw water introduced from the water inlet flow path 2031 flows to the water outlet flow path 2032 in the backflushing mode. In addition, the bypass flow path 2033 may have one end connected to the water inlet flow path 2031 and the other end connected to the water outlet flow path 2032.

The drain flow path 2034 may provide a passage through which purified water sequentially passing through the second filter 2400 and the first filter 2300 flows. For example, the drain flow path 2034 may guide the flow of purified water so that the purified water sequentially passing through the second filter 2400 and the first filter 2300 flows to the outside in the backflushing mode. The drain flow path 2034 may be branched from the water inlet flow path 2031.

The valve unit 2040 may include a plurality of valve modules 2041, 2042, 2043 selectively opened and closed to control the flow of raw water and purified water in the flow path unit 2030. The plurality of valve modules 2041, 2042, 2043 may include a first valve module 2041, a second valve module 2042, and a third valve module 2043.

The first valve module 2041 may be selectively opened and closed to control the flow of raw water in the water inlet flow path 2031 and the bypass flow path 2033. For example, the first valve module 2041 may block the bypass flow path 2033 so that raw water flows toward the inlet 2110 in a purified water discharge mode to be described later. As another example, the first valve module 2041 may open the bypass flow path 2033 so that raw water flows into the bypass flow path 2033 in the backflushing mode.

The second valve module 2042 may be selectively opened and closed to control the flow of raw water and purified water in the water outlet flow path 2032 and the bypass flow path 2033. For example, the second valve module 2042 may block the bypass flow path 2033 so that purified water discharged from the outlet 2120 is discharged to the outside in the purified water discharge mode. As another example, the second valve module 2042 may open the bypass flow path 2033 so that raw water introduced into the bypass flow path 2033 from the water inlet flow path 2031 flows to the water outlet flow path 2032, in the backflushing mode.

The third valve module 2043 may be selectively opened and closed to control the flow of raw water and purified water in the drain flow path 2034 and the water inlet flow path 2031. For example, the third valve module 2043 may block the drain flow path 2034 so that raw water does not flow into the drain flow path 2034 in the purified water discharge mode. As another example, the third valve module 2043 may open the drain flow path 2034 so that purified water discharged from the inlet 2110 flows into the drain flow path 2034 in the backflushing mode.

The control device 2050 may be placed in any one of the purified water discharge mode and the backflushing mode. The control device 2050 may control the opening and closing of the plurality of valve modules 2041, 2042, 2043 to control the flow of raw water and purified water when placed in either the purified water discharge mode or the backflushing mode. The control device 2050 may be implemented by a computing device including a microprocessor, a measuring device such as a sensor, and a memory, and the implementation method is obvious to those skilled in the art, so further detailed descriptions will be omitted.

Hereinafter, the action and effect of the water purifier 1 having the above-described configuration will be described.

When the water purifier 1 receives an input of the purified water discharge mode from a user, the water purifier 1 may filter raw water and provide purified water to the user. In this case, referring back to FIG. 12, raw water flows along the water inlet flow path 2031 and flows into the inlet 2110, and the raw water flowing into the inlet 2110 flows along the raw water flow path F1. In addition, raw water flowing along the raw water flow path F1 flows between the housing 2100 and the upper cap member 2210 and between the housing 2100 and the filter outer body 2311 and flows into the communication hole 2311a.

The raw water flowing into the communication hole 2311a is filtered through the plurality of hollow fibers 2321. In this case, the raw water is filtered into purified water while passing through the through hole 2321b of the hollow fiber 2321, and flows along the fiber passage 2321a and is discharged toward the upper cap member 2210 and the lower cap member 2220. In other words, some of the purified water flowing along the fiber passage 2321a is discharged upward, and others are discharged downward. In addition, purified water discharged to the upper cap member 2210 and the lower cap member 2220 flows along the transfer flow path F2 and flows between the filter inner body 2312 and the second filter 2400.

The purified water flowing between the filter inner body 2312 and the second filter 2400 is filtered once more while passing through the second filter 2400. The purified water passing through the second filter 2400 flows along the discharge flow path F3, sequentially passes through the cap hole 2211a, the upper cap outlet part 2214, and the outlet 2120 and flows into the water outlet flow path 2032. In addition, the purified water introduced into the water outlet flow path 2032 may be discharged to the outside and provided to the user.

Meanwhile, if the first filter 2300 and the second filter 2400 are used for a long period of time, contaminants may block the through hole 2321b. Because of this, the filtration performance of the first filter 2300 may deteriorate. In this case, the user may improve the filtration performance of the first filter 2300 through the backflushing mode.

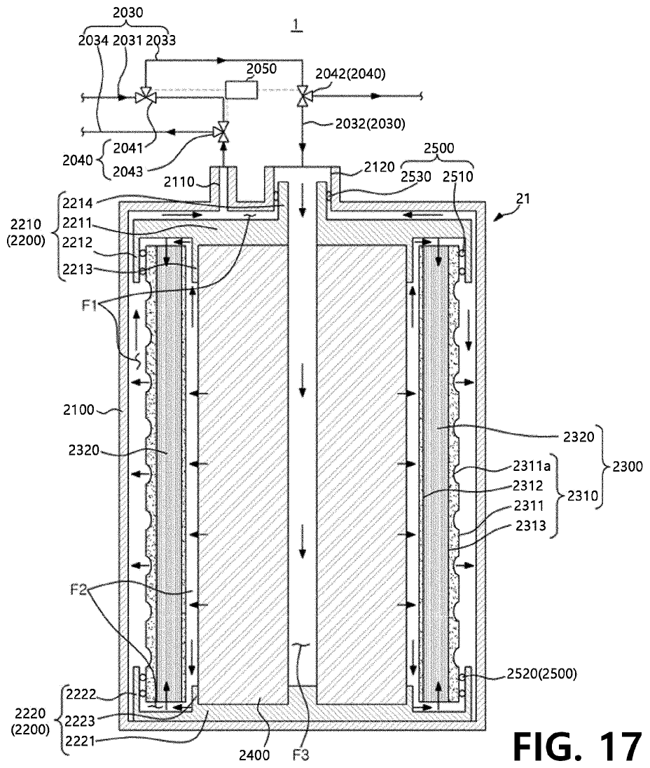

When the water purifier 1 receives the backflushing mode from the user, the water purifier 1 may remove contaminants remaining in the first filter 2300. In this case, referring to FIG. 17, raw water flows along the water inlet flow path 2031 and flows into the bypass flow path 2033, and the raw water flowing into the bypass flow path 2033 flows into the water outlet flow path 2032. In addition, the raw water introduced into the water outlet flow path 2032 flows toward the outlet 2120, and the raw water flowing into the outlet 2120 flows along the discharge flow path F3.

The raw water flowing along the discharge flow path F3 passes through the second filter 2400 and is filtered into purified water. In addition, the purified water passing through the second filter 2400 flows along the transfer flow path F2 and flows into the plurality of hollow fibers 2321. In this case, the purified water introduced into the hollow fiber 2321 passes through the plurality of through holes 2321b to remove contaminants from the plurality of through holes 2321b.

In addition, the purified water passing through the plurality of hollow fibers 2321 sequentially passes through the communication hole 2311a, the raw water flow path F1, and the inlet 2110 while containing contaminants. In this way, the purified water sequentially passing through the second filter 2400 and the first filter 2300 and discharged from the inlet 2110 flows into the drain flow path 2034 while containing contaminants, and may be drained to the outside through the drain flow path 2034.

As such, the water purifier 1 according to an exemplary embodiment of the present invention may improve the filtration performance of the first filter 2300 by removing contaminants remaining in the hollow fiber 2321 through the backflushing mode even if the contaminants block the through hole 2321b of the hollow fiber 2321.

In addition, in the backflushing mode, purified water from which contaminants have been primarily filtered through the second filter 2400 passes through the first filter 2300, thereby capable of removing contaminants remaining in the first filter 2300 without contaminating the first filter 2300.

Meanwhile, the first filter 2300 is provided in a ring shape and the second filter 2400 is disposed inside the ring, thereby capable of minimizing the volume occupied by the first filter 2300 and the second filter 2400 in the frame 10.

In addition, the volume of the first filter 2300 and the second filter 2400 is minimized, so that the water purifier 1 can be miniaturized.

### 5. Description of the Filter Assembly 22 According to the Third Embodiment of the Present Invention

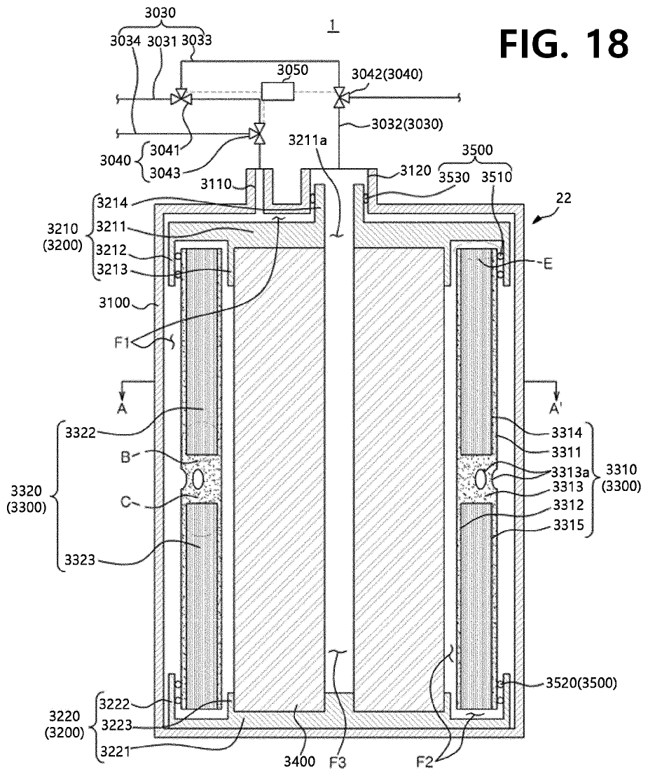

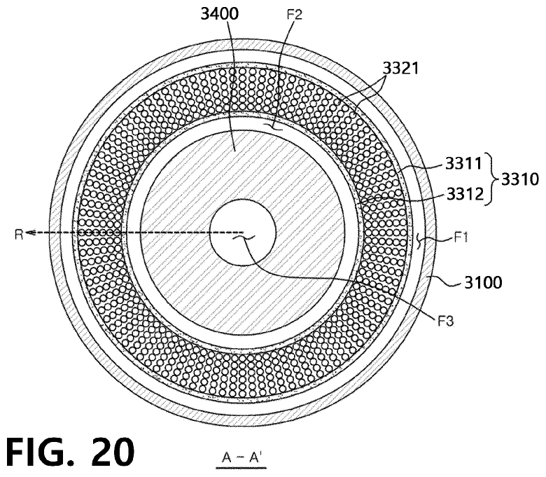

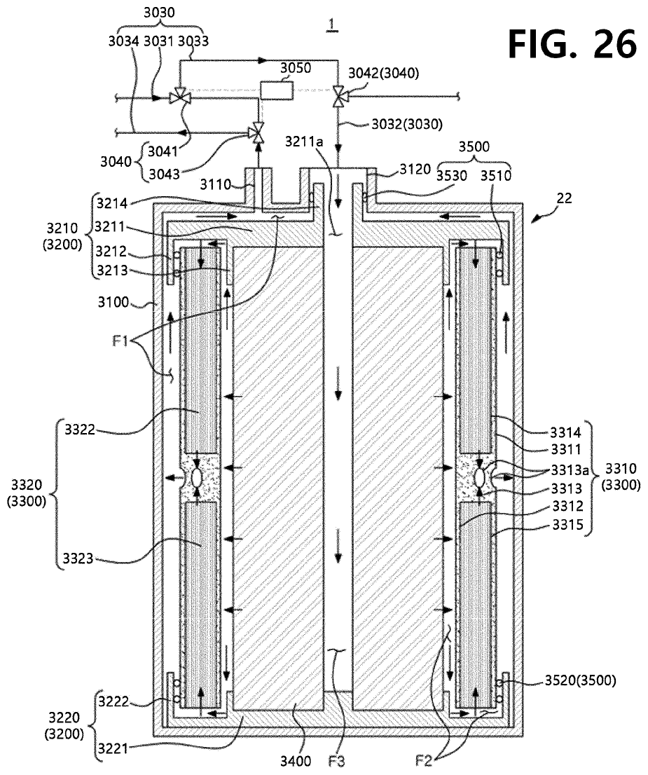

Hereinafter, the filter assembly 22 according to the third embodiment of the present invention will be described in detail with reference to FIGS. 18 to 26. Hereinafter, the up-down direction may be the up-down direction of FIGS. 1, 18 to 19, and 26, and the radial direction may be the radial direction R of FIG. 20.

Hereinafter, referring to FIGS. 1 and 18, the water purifier 1 according to an exemplary embodiment of the present invention may provide clean water to a user by filtering water supplied from the outside. For example, the water purifier 1 may receive water from a water supply source (not shown) such as water supply, and may filter the received water into clean water. This water purifier 1 may include a frame 10, a filter assembly 22, a flow path unit 3030, a valve unit 3040, and a control device 3050.

Meanwhile, water introduced into the filter assembly 22 from the outside may be divided into raw water and purified water. Hereinafter, water that has not passed through a first filter 3300 and a second filter 3400 to be described later among water introduced into the water purifier 1 from the outside is defined as raw water, and water filtered through any one of the first filter 3300 and the second filter 3400 is defined as purified water.

The frame 10 may accommodate the filter assembly 22, the flow path unit 3030, the valve unit 3040, and the control device 3050 therein, and may support the filter assembly 22, the flow path unit 3030, the valve unit 3040, and the control device 3050.

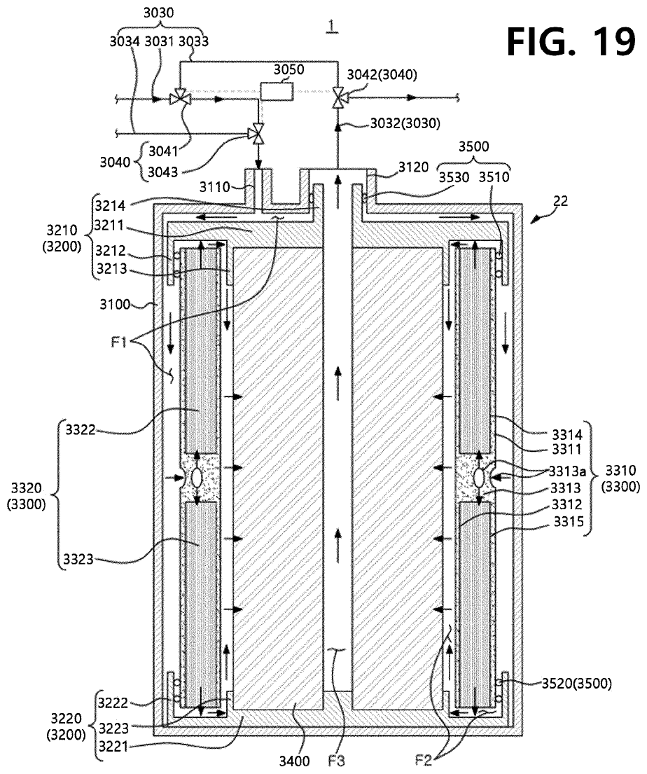

Referring to FIGS. 18 and 19, the filter assembly 22 may filter raw water and provide purified water to a user. The filter assembly 22 may be attached to or detached from the frame 10. For example, if the filter assembly 22 is used for a long time and the filtration performance is deteriorated, it may be replaced with another filter assembly 22. In addition, purified water passing through the filter assembly 22 may be discharged to the outside. The filter assembly 22 may include a housing 3100, a cap 3200, a first filter 3300, a second filter 3400, and a sealing unit 3500.

A space for accommodating the cap 3200, the first filter 3300, the second filter 3400, and the sealing unit 3500 may be formed in the housing 3100, and the cap 3200, the first filter 3300, the second filter 3400, and the sealing unit 3500 may be accommodated in the inner space of the housing 3100. An inlet 3110 through which raw water is introduced and an outlet 3120 for discharging purified water to the outside of the housing 3100 may be formed in the housing 3100. For example, the inlet 3110 and the outlet 3120 may be formed at an upper portion of the housing 3100. In addition, the inlet 3110 may communicate with a water inlet flow path 3031 to be described later, and the outlet 3120 may communicate with a water outlet flow path 3032 to be described later.

The cap 3200 may be disposed inside the housing 3100 to support the first filter 3300, the second filter 3400, and the sealing unit 3500. In addition, the cap 3200 may guide the flow of raw water and purified water so that raw water and purified water flowing inside the housing 3100 flow toward the first filter 3300, the second filter 3400, and the outlet 3120. The cap 3200 may include an upper cap member 3210 and a lower cap member 3220.

The upper cap member 3210 may be disposed inside the housing 3100, and may be disposed above the lower cap member 3220. The upper cap member 3210 may support upper portions of the first filter 3300 and the second filter 3400. In addition, a raw water flow path F1 through which raw water may flow may be formed between the upper cap member 3210 and the inner surface of the housing 3100. The raw water flow path F1 may provide a passage for raw water introduced through the inlet 3110 into the housing 3100 to flow to the first filter 3300. Here, the raw water flow path F1 may be a concept including a passage between the housing 3100 and the first filter 3300 as well as a passage between the housing 3100 and the upper cap member 3210.

In addition, the upper cap member 3210 may be configured to be spaced apart upward by a predetermined distance from the upper end portion of the first filter 3300. In other words, the inner surface of the upper cap member 3210 may be spaced apart from the upper end of the first filter 3300 in the up-down direction. In addition, a transfer flow path F2 through which purified water passing through the first filter 3300 can flow may be formed between the upper cap member 3210 and the upper end of the first filter 3300. The transfer flow path F2 may provide a passage for purified water passing through the first filter 3300 to flow to the second filter 3400. Here, the transfer flow path F2 may be a concept including a passage between the first filter 3300 and the second filter 3400 as well as a passage between the first filter 3300 and the upper cap member 3210.

The upper cap member 3210 may include an upper cap body part 3211, a first upper cap support part 3212, a second upper cap support part 3213, and an upper cap outlet part 3214.

The upper cap body part 3211 may be in contact with the upper end of the second filter 3400 to support the second filter 3400. The upper cap body part 3211 may be spaced apart upward by a predetermined distance from the upper end of the first filter 3300 to form a part of the transfer flow path F2. In addition, the upper cap body part 3211 may be spaced apart a predetermined distance downward from the inner surface of the housing 3100 to form a part of the raw water flow path F1. A cap hole 3211a for allowing the purified water passing through the second filter 3400 to flow to the outlet 3120 may be formed in the upper cap body part 3211.

The first upper cap support part 3212 may extend downward from the upper cap body part 3211 to support the first filter 3300. For example, the first upper cap support part 3212 may protrude downward from the circumferential surface of the upper cap body part 3211. In addition, the first upper cap support part 3212 may extend to surround the outer circumferential surface of the upper end of the first filter 3300. The first upper cap support part 3212 may be spaced apart from the inner surface of the housing 3100 to form a part of the raw water flow path F1.

The second upper cap support part 3213 may extend downward from the upper cap body part 3211 to support the second filter 3400. For example, the second upper cap support part 3213 may protrude downward from the upper cap body part 3211. In addition, the second upper cap support part 3213 may extend to surround the outer circumferential surface of the upper end of the second filter 3400. The second upper cap support part 3213 may be disposed between the inner circumferential surface of the first filter 3300 and the outer circumferential surface of the second filter 3400. In addition, the second upper cap support part 3213 may be laterally spaced apart from the first filter 3300 so that purified water flowing along the transfer flow path F2 flows between the first filter 3300 and the second filter 3400.

The upper cap outlet part 3214 may provide a passage for discharging purified water flowing inside the cap 3200. The upper cap outlet part 3214 may extend upward from the upper cap body part 3211 and may communicate with the cap hole 3211a. In addition, at least a portion of the upper cap outlet part 3214 may be inserted into the outlet 3120. The purified water may flow to the outlet 3120 by the upper cap outlet part 3214.

The lower cap member 3220 may be disposed inside the housing 3100 and may support lower portions of the first filter 3300 and the second filter 3400. In addition, the lower cap member 3220 may be configured to be spaced downward by a predetermined distance from the lower end portion of the second filter 3400. In addition, a transfer flow path F2 through which purified water can flow may be formed between the lower cap member 3220 and the lower end of the first filter 3300.

The lower cap member 3220 may include a lower cap body part 3221, a first lower cap support part 3222, and a second lower cap support part 3223.

The lower cap body part 3221 may be in contact with the lower end of the second filter 3400 to support the second filter 3400. The lower cap body part 3221 may be spaced apart downward by a predetermined distance from the lower end of the first filter 3300 to form a part of the transfer flow path F2.

The first lower cap support part 3222 may extend upward from the lower cap body part 3221 to support the first filter 3300. For example, the first lower cap support part 3222 may protrude upward from the circumferential surface of the lower cap body part 3221. In addition, the first lower cap support part 3222 may extend to surround the outer circumferential surface of the lower end of the first filter 3300.

The second lower cap support part 3223 may extend upward from the lower cap body part 3221 to support the second filter 3400. For example, the second lower cap support part 3223 may protrude upward from the lower cap body part 3221 while being spaced laterally from the first lower cap support part 3222. In addition, the second lower cap support part 3223 may extend to surround the outer circumferential surface of the lower end of the second filter 3400. The second lower cap support part 3223 may be disposed between the inner circumferential surface of the first filter 3300 and the outer circumferential surface of the second filter 3400. In addition, the second lower cap support part 3223 may be laterally spaced apart from the first filter 3300 so that purified water flowing along the transfer flow path F2 flows between the first filter 3300 and the second filter 3400.

Referring to FIG. 20, the first filter 3300 may be accommodated in the housing 3100 and may filter raw water to provide purified water. In addition, when viewed from the top, the first filter 3300 may be spaced apart from the outside of the second filter 3400 by a predetermined distance and extend in a ring shape to surround at least a portion of the second filter 3400. The first filter 3300 may include a fiber support 3310, a filter member 3320, and a filter holder 3330.

The fiber support 3310 may support the filter member 3320, and may provide a first accommodation part 3314 and a second accommodation part 3315, which are spaces in which the filter member 3320 may be accommodated. The fiber support 3310 may be supported by the cap 3200 and may extend to surround the second filter 3400 when viewed from the top. In addition, the fiber support 3310 may include a filter outer body 3311, a filter inner body 3312, and a filter support body 3313.

When viewed from the top, the filter outer body 3311 may be spaced apart from the filter inner body 3312 by a predetermined distance, and may extend in a ring shape to surround the filter inner body 3312. The filter outer body 3311 may extend in the up-down direction from the filter support body 3313.

When viewed from the top, the filter inner body 3312 may be spaced apart from the second filter 3400 by a predetermined distance, and may extend in a ring shape to surround the second filter 3400. In addition, the filter inner body 3312 may be disposed between the filter outer body 3311 and the second filter 3400. The filter inner body 3312 may extend in the up-down direction from the filter support body 3313.

The filter support body 3313 may connect the filter outer body 3311 and the filter inner body 3312, and may support the filter outer body 3311 and the filter inner body 3312. The filter support body 3313 may provide the first accommodation part 3314 and the second accommodation part 3315 together with the filter outer body 3311 and the filter inner body 3312.

Meanwhile, a communication hole 3313a through which raw water flows may be formed in the filter support body 3313. The communication hole 3313a may be formed through the filter support body 3313, and may communicate with the first accommodation part 3314 and the second accommodation part 3315. In addition, the communication hole 3313a may communicate with the raw water flow path F1. For example, raw water flowing along the raw water flow path F1 may flow toward the first accommodation part 3314 and the second accommodation part 3315 through the communication hole 3313a.

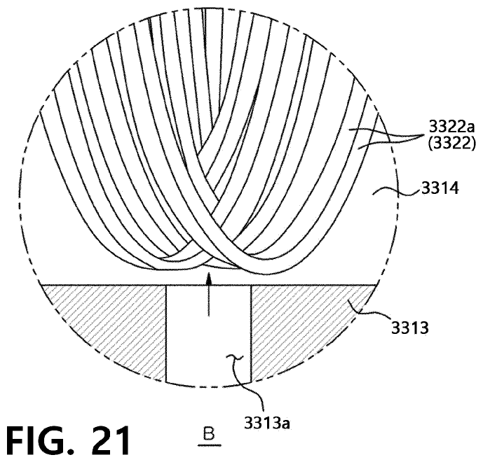

Referring to FIG. 21, the first accommodation part 3314 may accommodate a first filter member 3322, which will be described later. The first accommodation part 3314 may be formed to be surrounded by the filter support body 3313, the filter outer body 3311, and the filter inner body 3312. In addition, the first accommodation part 3314 may be located above the second accommodation part 3315.

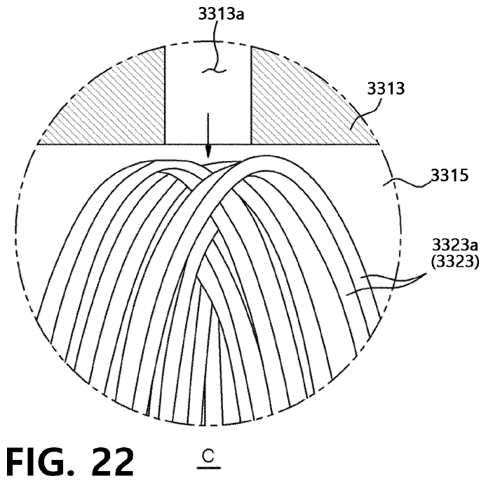

Referring to FIG. 22, the second accommodation part 3315 may accommodate a second filter member 3323, which will be described later. The second accommodation part 3315 may be formed to be surrounded by the filter support body 3313, the filter outer body 3311, and the filter inner body 3312.

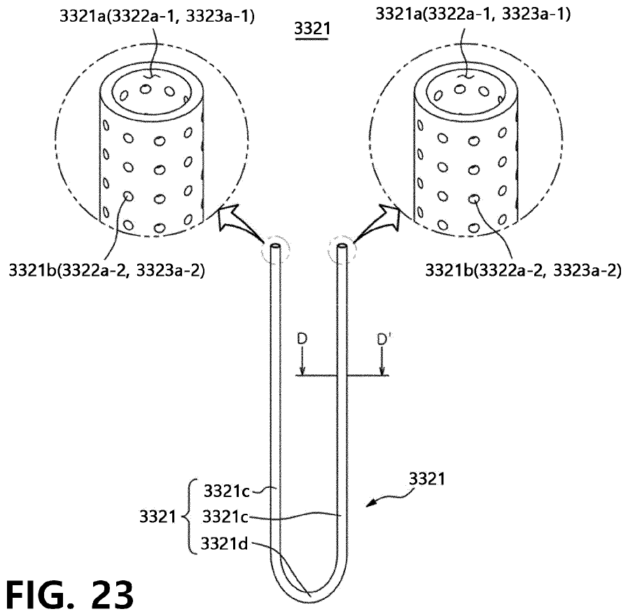

Referring to FIG. 23, the filter member 3320 may filter raw water to provide purified water. The filter member 3320 may include a plurality of hollow fibers 3321 for filtering raw water. The plurality of hollow fibers 3321 may filter raw water introduced from the communication hole 3313a to provide purified water. In addition, the plurality of hollow fibers 3321 may discharge purified water toward the upper cap body part 3211 and the lower cap body part 3221 so that purified water flows along the transfer flow path F2.

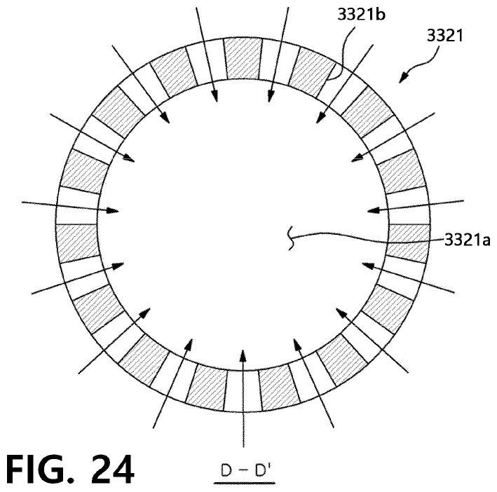

Referring to FIGS. 23 and 24, the hollow fiber 3321 may have a predetermined length, and may extend to have a ‘U’ shape. In addition, a plurality of hollow fibers 3321 are provided, and the plurality of hollow fibers 3321 may be combined with each other by the filter holder 3330. The hollow fiber 3321 may include a fiber passage 3321a, a through hole 3321b, an extension part 3321c, and a connection part 3321d.

The fiber passage 3321a may be a passage provided inside the extension part 3321c and the connection part 3321d so that the filtered purified water flows. In other words, the fiber passage 3321a may be a passage that penetrates the central portion of the hollow fiber 3321 and extends in the longitudinal direction of the hollow fiber 3321. The purified water introduced into the fiber passage 3321a may flow in the longitudinal direction of the hollow fiber 3321. In addition, the hollow fiber 3321 may be bent so that both ends of the fiber passage 3321a are open toward the same side.

The through hole 3321b may communicate with the fiber passage 3321a so that raw water introduced into the fiber support 3310 flows into the fiber passage 3321a. The through hole 3321b is formed through the extension part 3321c and the connection part 3323d, and may extend in a direction that deviates from the direction in which the fiber passage 3321a extends. In addition, a plurality of through holes 3321b may be provided, and the plurality of through holes 3321b may be disposed to be spaced apart in the longitudinal direction of the hollow fiber 3321. For example, the size of the through hole 3321b may be 18 nm to 22 nm.

A plurality of extension parts 3321c may be provided, and the plurality of extension parts 3321c may extend from both ends of the connection part 3321d, respectively. One ends of the plurality of extension parts 3321c may face the same side, and the other ends of the plurality of extension parts 3321c may be supported by the filter holder 3330.

The connection part 3323d may connect the plurality of extension parts 3321c to the central portion of the hollow fiber 3321.

Meanwhile, a plurality of filter members 3320 may be provided, and the plurality of filter members 3320 may include a first filter member 3322 and a second filter member 3323.

The first filter member 3322 may be accommodated in the first accommodation part 3314, and may discharge purified water toward the upper cap member 3210. The first filter member 3322 may include a plurality of hollow fibers 3321. Hereinafter, a plurality of hollow fibers 3321 provided to the first filter member 3322 are referred to as a first fiber 3322a.

A plurality of first fibers 3322a may be provided, and may filter raw water introduced into the first accommodation part 3314 to provide purified water. The above-described fiber passage 3321a and through hole 3321b may be formed in the first fiber 3322a. In the present specification, the fiber passage 3321a of the first fiber 3322a may be referred to as a first passage 3322a-1, and the through hole 3321b of the first fiber 3322a may be referred to as a first through hole 3322a-2.

Meanwhile, the first fiber 3322a may extend in a U shape, and may be bent so that both ends of the first passage 3322a-1 are open upward. In this case, the purified water flowing along the first fiber 3322a may be discharged upward, and the purified water may flow into the transfer flow path F2 between the upper cap member 3210 and the first filter 3300.

The second filter member 3323 may be accommodated in the second accommodation part 3315, and may discharge purified water toward the lower cap member 3220. The second filter member 3323 may be disposed in the lower portion of the first filter 3300. In addition, the second filter member 3323 may include a plurality of hollow fibers 3321. Hereinafter, a plurality of hollow fibers 3321 provided to the second filter member 3323 are referred to as a second fiber 3323a.

A plurality of second fibers 3323a may be provided, and may filter raw water introduced into the second accommodation part 3315 to provide purified water. The above-described fiber passage 3321a and through hole 3321b may be formed in the second fiber 3323a. In the present specification, the fiber passage 3321a of the second fiber 3323a may be referred to as a second passage 3323a-1, and the through hole 3321b of the second fiber 3323a may be referred to as a second through hole 3323a-2.

Meanwhile, the second fiber 3323a may extend in a U shape, and may be bent so that both ends of the second passage 3323a-1 are open downward. In this case, the purified water flowing along the second fiber 3323a may be discharged downward, and the purified water may flow into the transfer flow path F2 between the lower cap member 3220 and the first filter 3300.

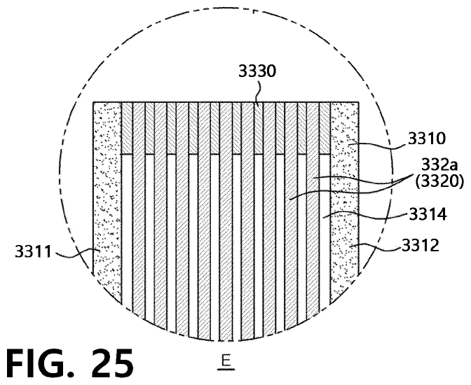

Referring to FIG. 25, the filter holder 3330 may couple a plurality of hollow fibers 3321 and a fiber support 3310. For example, the filter holder 3330 may couple a plurality of first fibers 3322a and a fiber support 3310. In this case, the plurality of first fibers 3322a may be disposed in the first accommodation part 3314 by the filter holder 3330. In addition, the filter holder 3330 may couple a plurality of second fibers 3323a and a fiber support 3310. In this case, the plurality of second fibers 3323a may be disposed in the second accommodation part 3315 by the filter holder 3330. A plurality of filter holders 3330 may be provided, and the plurality of filter holders 3330 may be provided to the first accommodation part 3314 and the second accommodation part 3315, respectively. For example, the filter holder 3330 may include urethane or the like.

The second filter 3400 may filter purified water. The second filter 3400 may be placed inside the first filter 3300, and may secondly re-filter purified water that has been primarily filtered by the first filter 3300. For example, the second filter 3400 may include a carbon filter. In addition, the second filter 3400 may have a ring shape, and a discharge flow path F3 through which purified water or raw water flows may be formed inside the second filter 3400. The discharge flow path F3 may be provided by the second filter 3400, the cap hole 3211a, the upper cap outlet part 3214, and the inlet 3110.

The sealing unit 3500 may limit the flow of raw water and purified water flowing inside the housing 3100. The sealing unit 3500 may include a first sealing member 3510, a second sealing member 3520, and a third sealing member 3530.

The first sealing member 3510 may seal between the upper cap member 3210 and the first filter 3300. In other words, the first sealing member 3510 may seal between the first upper cap support part 3212 and the filter outer body 3311. For example, the first sealing member 3510 may prevent purified water flowing along the transfer flow path F2 from being introduced between the first filter 3300 and the housing 3100 and mixed with raw water flowing along the raw water flow path F1.

The second sealing member 3520 may seal between the lower cap member 3220 and the first filter 3300. In other words, the second sealing member 3520 may seal between the first lower cap support part 3222 and the filter outer body 3311. For example, it may prevent purified water flowing along the transfer flow path F2 from flowing between the first filter 3300 and the housing 3100 and mixed with raw water flowing along the raw water flow path F1.

The third sealing member 3530 may seal between the housing 3100 and the upper cap member 3210. In other words, the third sealing member 3530 may seal between the outlet 3120 and the upper cap outlet part 3214. For example, the third sealing member 3530 can prevent raw water in the raw water flow path F1 from being discharged to the outside through the outlet 3120.

The flow path unit 3030 may provide a passage through which raw water and purified water flow. The flow path unit 3030 may include a water inlet flow path 3031, a water outlet flow path 3032, a bypass flow path 3033, and a drain flow path 3034.

The water inlet flow path 3031 may provide a passage through which raw water flows to the inlet 3110. For example, the water inlet flow path 3031 may guide the flow of raw water so that the raw water introduced into the water purifier 1 flows toward the inside of the filter assembly 22. The water inlet flow path 3031 may be connected to the inlet 3110 and may communicate with the raw water flow path F1.

In addition, the water inlet flow path 3031 may provide a passage through which purified water flows. For example, the water inlet flow path 3031 may guide the flow of purified water so that purified water sequentially passing through the second filter 3400 and the first filter 3300 flows to the drain flow path 3034 in a backflushing mode to be described later.

The water outlet flow path 3032 may provide a passage through which purified water discharged from the outlet 3120 flows. For example, the water outlet flow path 3032 may guide the flow of purified water so that the purified water sequentially passing through the first filter 3300 and the second filter 3400 flows toward the outside. The water outlet flow path 3032 may be connected to the outlet 3120 and may communicate with the discharge flow path F3.

In addition, the water outlet flow path 3032 may provide a passage through which raw water flows. For example, the water outlet flow path 3032 may guide the flow of raw water so that the raw water introduced through the bypass flow path 3033 flows to the outlet 3120 in the backflushing mode.

The bypass flow path 3033 may provide a passage for raw water to flow, and may communicate the water inlet flow path 3031 with the water outlet flow path 3032. For example, the bypass flow path 3033 may guide the flow of raw water so that the raw water introduced from the water inlet flow path 3031 flows to the water outlet flow path 3032 in the backflushing mode. In addition, the bypass flow path 3033 may have one end connected to the water inlet flow path 3031 and the other end connected to the water outlet flow path 3032.

The drain flow path 3034 may provide a passage through which purified water sequentially passing through the second filter 3400 and the first filter 3300 flows. For example, the drain flow path 3034 may guide the flow of purified water so that the purified water sequentially passing through the second filter 3400 and the first filter 3300 flows to the outside in the backflushing mode. The drain flow path 3034 may be branched from the water inlet flow path 3031.

The valve unit 3040 may include a plurality of valve modules 3041, 3042, 3043 selectively opened and closed to control the flow of raw water and purified water in the flow path unit 3030. The plurality of valve modules 3041, 3042, 3043 may include a first valve module 3041, a second valve module 3042, and a third valve module 3043.

The first valve module 3041 may be selectively opened and closed to control the flow of raw water in the water inlet flow path 3031 and the bypass flow path 3033. For example, the first valve module 3041 may block the bypass flow path 3033 so that raw water flows toward the inlet 3110 in a purified water discharge mode to be described later. As another example, the first valve module 3041 may open the bypass flow path 3033 so that raw water flows into the bypass flow path 3033 in the backflushing mode.

The second valve module 3042 may be selectively opened and closed to control the flow of raw water and purified water in the water outlet flow path 3032 and the bypass flow path 3033. For example, the second valve module 3042 may block the bypass flow path 3033 so that purified water discharged from the outlet 3120 is discharged to the outside in the purified water discharge mode. As another example, the second valve module 3042 may open the bypass flow path 3033 so that raw water introduced into the bypass flow path 3033 from the water inlet flow path 3031 flows into the water outlet flow path 3032, in the backflushing mode.

The third valve module 3043 may be selectively opened and closed to control the flow of raw water and purified water in the drain flow path 3034 and the water inlet flow path 3031. For example, the third valve module 3043 may block the drain flow path 3034 so that raw water does not flow into the drain flow path 3034 in the purified water discharge mode. As another example, the third valve module 3043 may open the drain flow path 3034 so that purified water discharged from the inlet 3110 flows into the drain flow path 3034 in the backflushing mode.

The control device 3050 may be placed in any one of the purified water discharge mode and the backflushing mode. The control device 3050 may control the opening and closing of the plurality of valve modules 3041, 3042, 3043 to control the flow of raw water and purified water when placed in either the purified water discharge mode or the backflushing mode. The control device 3050 may be implemented by a computing device including a microprocessor, a measuring device such as a sensor, and a memory, and the implementation method is obvious to those skilled in the art, so further detailed descriptions will be omitted.

Hereinafter, the action and effect of the water purifier 1 having the above-described configuration will be described.

When the water purifier 1 receives an input of the purified water discharge mode from a user, the water purifier 1 may filter raw water and provide purified water to the user. In this case, referring to FIG. 3, raw water flows along the water inlet flow path 3031 and flows into the inlet 3110, and the raw water flowing into the inlet 3110 flows along the raw water flow path F1. In addition, raw water flowing along the raw water flow path F1 flows between the housing 3100 and the upper cap member 3210 and between the housing 3100 and the filter outer body 3311 and flows into the communication hole 3313a.

A part of the raw water introduced into the communication hole 3313a is filtered by a plurality of first fibers 3322a accommodated in the first accommodation part 3314. In this case, the raw water is filtered into purified water while passing through the first through hole 3322a-2 of the first fiber 3322a, and the purified water flows along the first passage 3322a-1 and is discharged toward the upper cap body part 3211. In addition, purified water discharged to the upper cap body part 3211 flows along the transfer flow path F2 and flows between the filter inner body 3312 and the second filter 3400.

In addition, other parts of the raw water introduced into the communication hole 3313a is filtered by a plurality of second fibers 3323a accommodated in the second accommodation part 3315. In this case, the raw water is filtered into purified water while passing through the second through hole 3323a-2 of the second fiber 3323a, and the purified water flows along the second passage 3323a-1 and is discharged toward the lower cap body part 3221. In addition, purified water discharged to the lower cap body part 3221 flows along the transfer flow path F2 and flows between the filter inner body 3312 and the second filter 3400.

The purified water flowing between the filter inner body 3312 and the second filter 3400 is filtered once more while passing through the second filter 3400. The purified water passing through the second filter 3400 flows along the discharge flow path F3, sequentially passes through the cap hole 3211a, the upper cap outlet part 3214, and the outlet 3120 and flows into the water outlet flow path 3032. In addition, the purified water introduced into the water outlet flow path 3032 may be discharged to the outside and provided to the user.

Meanwhile, if the first filter 3300 and the second filter 3400 are used for a long period of time, contaminants may block the first through hole 3322a-2 and the second through hole 3323a-2. Because of this, the filtration performance of the first filter 3300 may deteriorate. In this case, the user may improve the filtration performance of the first filter 3300 through the backflushing mode.

When the water purifier 1 receives the backflushing mode from the user, the water purifier 1 may remove contaminants remaining in the first filter 3300. In this case, referring to FIG. 10, raw water flows along the water inlet flow path 3031 and flows into the bypass flow path 3033, and the raw water flowing into the bypass flow path 3033 flows into the water outlet flow path 3032. In addition, the raw water introduced into the water outlet flow path 3032 flows toward the outlet 3120, and the raw water flowing into the outlet 3120 flows along the discharge flow path F3.

The raw water flowing along the discharge flow path F3 passes through the second filter 3400 and is filtered into purified water. In addition, the purified water passing through the second filter 3400 flows along the transfer flow path F2 and flows into the first fiber 3322a and the second fiber 3323a. In this case, the purified water introduced into the first fiber 3322a and the second fiber 3323a passes through the first through-hole 3322a-2 and the second through-hole 3323a-2 to remove contaminants from the first through hole 3322a-2 and the second through hole 3323a-2.

In addition, the purified water passing through the first fiber 3322a and the second fiber 3323a sequentially passes through the communication hole 3313a, the raw water flow path F1, and the inlet 3110 while containing contaminants. In this way, the purified water sequentially passing through the second filter 3400 and the first filter 3300 and discharged from the inlet 3110 flows into the drain flow path 3034 while containing contaminants, and may be drained to the outside through the drain flow path 3034.

As such, the water purifier 1 according to an exemplary embodiment of the present invention may improve the filtration performance of the first filter 3300 by removing contaminants remaining in the hollow fiber 3321 through the backflushing mode even if the contaminants block the through hole 3321b of the hollow fiber 3321.

In addition, in the backflushing mode, purified water from which contaminants have been primarily filtered through the second filter 3400 passes through the first filter 3300, thereby capable of removing contaminants remaining in the first filter 3300 without contaminating the first filter 3300.

Meanwhile, the first filter 3300 is provided in a ring shape and the second filter 3400 is disposed inside the ring, thereby capable of minimizing the volume occupied by the first filter 3300 and the second filter 3400 in the frame 10.

In addition, the volume of the first filter 3300 and the second filter 3400 is minimized, so that the water purifier 1 can be miniaturized.

### 6. Description of the Filter Assembly 23 According to the Fourth Embodiment of the Present Invention

Hereinafter, the filter assembly 23 according to the fourth embodiment of the present invention will be described with reference to the drawings.

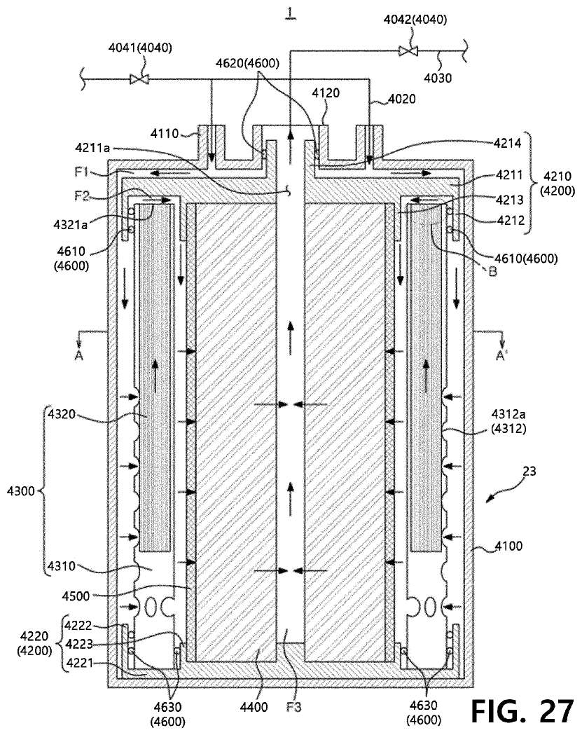

Referring to FIG. 27, the filter assembly 23 according to an exemplary embodiment of the present invention may provide clean water to a user by filtering water supplied from the outside. The filter assembly 23 may include a housing 4100, a cap 4200, a first filtering part 4300, a second filtering part 4400, a third filtering part 4500, and a sealing unit 4600.

Water introduced into the filter assembly 23 from the outside may be divided into raw water and purified water. Hereinafter, water that has not passed through any one of the first filtering part 4300, the second filtering part 4400, and the third filtering part 4500 among water introduced into the filter assembly 23 from the outside is defined as raw water, and water filtered through any one of the first filtering part 4300, the second filtering part 4400, and the third filtering part 4500 is defined as purified water. In addition, the filter assembly 23 may be included in a water purifier 41, receive raw water from a raw water line 4020, and discharge purified water to a purified water line 4030. In addition, the raw water line 4020 and the purified water line 4030 may be opened and closed through the valve unit 4040. The valve unit 4040 may include a raw water valve 4041 opening and closing the raw water line 4020 and a purified water valve 4042 opening and closing the purified water line 4030.

A space for accommodating the cap 4200, the first filtering part 4300, the second filtering part 4400, and the third filtering part 4500 may be formed inside the housing 4100. In addition, an inlet 4110 through which raw water is introduced and an outlet 4120 for discharging purified water to the outside may be formed in the housing 4100. One of the inlet 4110 and the outlet 4120 may be formed on one surface of the housing 4100, and the other may be formed on one surface of the housing 4100 or on the other surface opposite to the one surface. As an example, the inlet 4110 and the outlet 4120 may be formed on the upper surface of the housing 4100. As another example, the inlet 4110 may be formed on one of the upper surface and lower surface of the housing 4100, and the outlet 4120 may be formed on the other. In addition, the inlet 4110 may communicate with the raw water line 4020, and the outlet 4120 may communicate with the purified water line 4030.

The cap 4200 may be disposed inside the housing 4100 to support the first filtering part 4300, the second filtering part 4400, and the third filtering part 4500. In addition, the cap 4200 may be configured to guide raw water and purified water flowing inside the housing 4100 to the first filtering part 4300, the second filtering part 4400, the third filtering part 4500, and the outlet 4120. The cap 4200 may include an upper cap member 4210 and a lower cap member 4220.

The upper cap member 4210 may be disposed inside the housing 4100 and may be disposed above the lower cap member 4220 to support upper sides of the first filtering part 4300, the second filtering part 4400, and the third filtering part 4500. A raw water flow path F1 may be formed between the upper cap member 4210 and the inner surface of the housing 4100. The raw water flow path F1 may guide raw water introduced through the inlet 4110 into the housing 4100 to flow to the first filtering part 4300.

In addition, the upper cap member 4210 may be configured to be spaced apart by a predetermined distance from the upper end portion of the first filtering part 4300. A transfer flow path F2 may be formed between the upper cap member 4210 and the upper end portion of the first filtering part 4300. In other words, the inner surface of the upper cap member 4210 may be spaced apart from the upper end of the first filtering part 4300 in the up-down direction. The transfer flow path F2 may provide a passage for allowing purified water discharged from the first filtering part 4300 to flow between one of the second filtering part 4400 and the third filtering part 4500, and the first filtering part 4300.

The upper cap member 4210 may include an upper cap body 4211, a first upper cap support part 4212, a second upper cap support part 4213, and an upper cap outlet part 4214.

The upper cap body 4211 may be in contact with the upper ends of the second filtering part 4400 and the third filtering part 4500 to support the second filtering part 4400 and the third filtering part 4500. In addition, a cap hole 4211a for allowing purified water discharged from the second filtering part 4400 and the third filtering part 4500 to flow to the outlet 4120 may be formed in the upper cap body 4211. The upper cap body 4211 may be configured to be spaced apart from the upper end of the first filtering part 4300 by a predetermined distance to form the transfer flow path F2. In addition, the upper cap body 4211 may be spaced apart from the inner surface of the housing 4100 to form a part of the raw water flow path F1.

The first upper cap support part 4212 may extend downward from the upper cap body 4211 to support the first filtering part 4300. For example, the first upper cap support part 4212 may extend downward from the circumferential surface of the upper cap body 4211. In addition, the first upper cap support part 4212 may extend to surround the outer circumferential surface of the upper end of the first filtering part 4300. The first upper cap support part 4212 may be spaced apart from the inner surface of the housing 4100 to form a part of the raw water flow path F1.

The second upper cap support part 4213 may extend downward from the upper cap body 4211 to support the second filtering part 4400 or the third filtering part 4500. In addition, the second upper cap support part 4213 may extend to surround the outer circumferential surface of the upper end of the second filtering part 4400 or the third filtering part 4500. The second upper cap support part 4213 may be disposed inside the first upper cap support part 4212 to be located between any one of the second filtering part 4400 and the third filtering part 4500 and the first filtering part 4300. In addition, the second upper cap support part 4213 may be disposed to be spaced apart from the first filtering part 4300 so that purified water flowing in the transfer flow path F2 flows between any one of the second filtering part 4400 and the third filtering part 4500 and the first filtering part 4300.

The upper cap outlet part 4214 may provide a passage for discharging purified water flowing inside the cap 4200. The upper cap outlet part 4214 may extend upward from the upper cap body 4211 and may communicate with the cap hole 4211a. In addition, at least a portion of the upper cap outlet part 4214 may be inserted into the outlet 4120. The purified water may flow to the outlet 4120 by the upper cap outlet part 4214.

The lower cap member 4220 may support lower sides of the first filtering part 4300, the second filtering part 4400, and the third filtering part 4500. The lower cap member 4220 may include a lower cap body 4221, a first lower cap support part 4222, and a second lower cap support part 4223.

The lower cap body 4221 may be disposed below the first filtering part 4300, the second filtering part 4400, and the third filtering part 4500.

The first lower cap support part 4222 may extend upward from the lower cap body 4221 to support the first filtering part 4300. The first lower cap support part 4222 may extend upward from the circumferential surface of the lower cap body 4221 to surround the outer circumferential surface of the lower end of the first filtering part 4300.

The second lower cap support part 4223 may extend upward from the lower cap body 4221 to support the second filtering part 4400 or the third filtering part 4500. In addition, the second lower cap support part 4223 may extend to surround the outer circumferential surface of the lower end of the second filtering part 4400 or the third filtering part 4500. The second lower cap support part 4223 may be disposed inside the first lower cap support part 4222 to be located between any one of the second filtering part 4400 and the third filtering part 4500 and the first filtering part 4300.

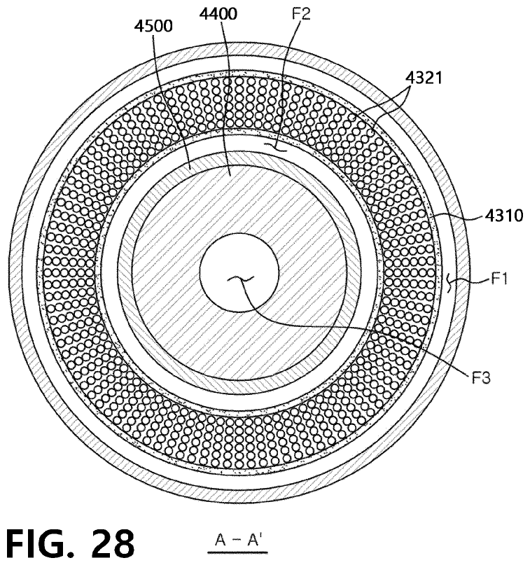

Referring further to FIG. 28, the first filtering part 4300 may be accommodated in the housing 4100 and may filter raw water to provide purified water. When viewed from the top, the first filtering part 4300 may be spaced a predetermined distance apart from the outside of the second filtering part 4400 and the third filtering part 4500, and may extend in a ring shape to surround at least a portion of the second filtering part 4400 and the third filtering part 4500. In addition, the first filtering part 4300 may include a fiber support 4310, a filter member 4320, and a filter holder 4330.

The fiber support 4310 may provide an accommodation part 4311, which is a space in which the filter member 4320 may be accommodated. The fiber support 4310 may be supported by the cap 4200 and may extend to surround the second filtering part 4400 and the third filtering part 4500 when viewed from the top. In addition, the fiber support 4310 may include a filter outer body 4312 and a filter inner body 4313.

When viewed from the top, the filter outer body 4312 may be spaced apart from the filter inner body 4313 by a predetermined distance, and may extend in a ring shape to surround the filter inner body 4313. A communication hole 4312a for flowing raw water to the filter member 4320 may be formed in the filter outer body 4312.

When viewed from the top, the filter inner body 4313 may be spaced a predetermined distance apart from the first filtering part 4300 and the second filtering part 4400, and may extend in a ring shape to surround the first filtering part 4300 and the second filtering part 4400. In other words, the filter inner body 4313 may be disposed between any one of the first filtering part 4300 and the second filtering part 4400 and the filter outer body 4312. The accommodation part 4311 may be formed between the filter inner body 4313 and the filter outer body 4312.

The filter member 4320 may include a plurality of hollow fibers 4321 for filtering raw water. The plurality of hollow fibers 4321 may filter raw water introduced from the communication hole 4312a to provide purified water. In addition, the plurality of hollow fibers 4321 may discharge purified water toward the upper cap body 4211 so that purified water flows in the transfer flow path F2.

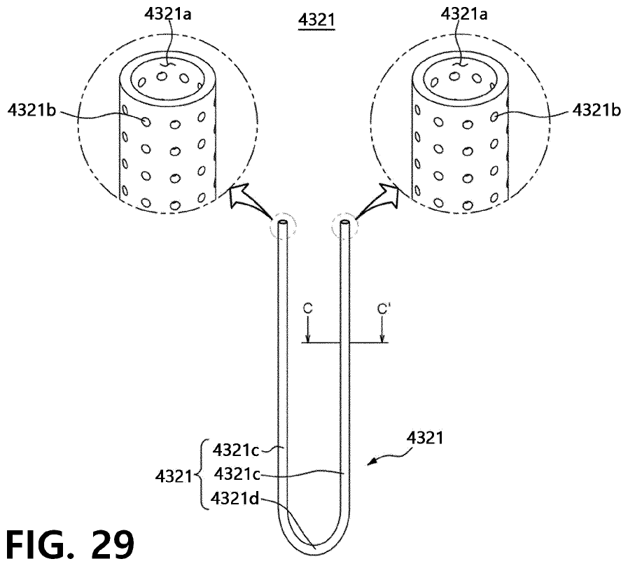

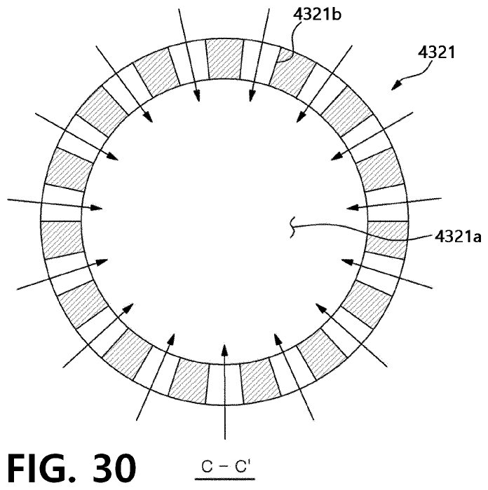

Referring further to FIGS. 29 and 30, for example, the hollow fiber 4321 may be formed such that a central portion thereof is disposed at a lower side than both ends thereof. The hollow fiber 4321 may include a fiber passage 4321a, a plurality of through holes 4321b, a plurality of extension parts 4321c, and a connection part 4321d.

The fiber passage 4321a may be a passage provided inside the extension part 4321c and the connection part 4321d so that the filtered purified water flows. The purified water may flow upward by the fiber passage 4321a and may be discharged to the transfer flow path F2.

The plurality of through holes 4321b may be formed in the extension part 4321c and the connection part 4321d so that raw water introduced into the fiber support 4310 flows into the fiber passage 4321a to communicate with the fiber passage 4321a. For example, the size of the through hole 4321b may be 18 nm to 22 nm.

Each of the plurality of extension parts 4321c may extend upward from both ends of the connection part 4321d. In addition, upper sides of the plurality of extension parts 4321c may be supported by the filter holder 4330.

The connection part 4321d may connect the plurality of extension parts 4321c to the central portion of the hollow fiber 4321.

As another example, a plurality of hollow fibers 4321 may extend in one direction from the upper cap member 4210 toward the lower cap member 4220. A fiber passage 4321a and a through hole 4321b may be formed in the plurality of hollow fibers 4321.

The fiber passage 4321a is a passage through which purified water flows, and may extend in one direction inside the hollow fiber 4321. The purified water may flow upward by the fiber passage 4321a and may be discharged to the transfer flow path F2.

The through hole 4321b may communicate with the fiber passage 4321a so that raw water introduced into the fiber support 4310 flows into the fiber passage 4321a.

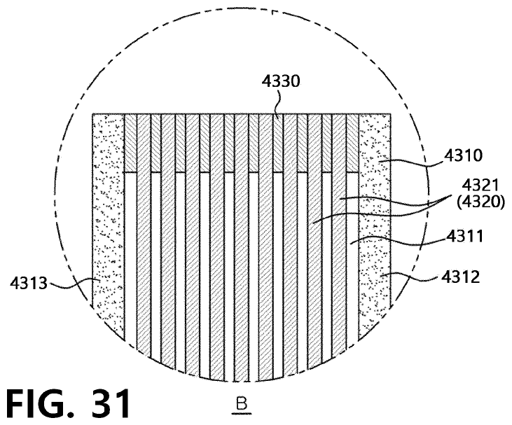

Referring further to FIG. 31, the filter holder 4330 may be disposed at the upper side of the accommodation part 4311 to couple the plurality of hollow fibers 4321 and the fiber support 4310. The plurality of hollow fibers 4321 may be placed in the accommodation part 4311 by the filter holder 4330. For example, the filter holder 4330 may include urethane or the like.

The second filtering part 4400 may re-filter purified water. The second filtering part 4400 may be disposed inside the first filtering part 4300. The second filtering part 4400 may include a carbon filter.

The third filtering part 4500 may include a positively charged layer for filtering purified water. The third filtering part 4500 may be disposed inside the first filtering part 4300. In other words, the third filtering part 4500 may be disposed inside the ring of the first filtering part 4300 in the radial direction together with the second filtering part 4400. The material forming the positively charged layer is not particularly limited, and for example, a known positively charged layer such as a polyamine-based having an amine group such as polyethyleneimine, diethylentriamine, piperazine, dimethylenpiperazine, diphenylamine, or glass fiber may be adopted.

One of the second filtering part 4400 and the third filtering part 4500 may extend to surround the other. For example, when viewed from the top, the third filtering part 4500 may extend to surround at least a portion of the second filtering part 4400. In addition, a purified water flow path F3 communicating with the cap hole 4211a may be formed inside the second filtering part 4400. The purified water discharged from the first filtering part 4300 may be sequentially filtered in the third filtering part 4500 and the second filtering part 4400 and flow to the outlet 4120 through the purified water flow path F3. As another example, when viewed from the top, the second filtering part 4400 may extend to surround at least a portion of the third filtering part 4500. In addition, a purified water flow path F3 communicating with the cap hole 4211a may be formed inside the third filtering part 4500. In addition, the purified water discharged from the first filtering part 4300 may be sequentially filtered in the second filtering part 4400 and the third filtering part 4500 and flow to the outlet 4120 through the purified water flow path F3.

The sealing unit 4600 may limit the flow of raw water and purified water flowing inside the housing 4100. The sealing unit 4600 may include a first sealing member 4610, a second sealing member 4620, and a third sealing member 4630.

The first sealing member 4610 may seal between the upper cap member 4210 and the first filtering part 4300 to prevent the purified water of the transfer flow path F2 from flowing between the first filtering part 4300 and the housing 4100 and being mixed with raw water. For example, the first sealing member 4610 may seal between the first upper cap support part 4212 and the first filtering part 4300.

The second sealing member 4620 may seal between the housing 4100 and the upper cap member 4210 to prevent the raw water of the raw water flow path F1 from being discharged to the outside through the outlet 4120. For example, the second sealing member 4620 may seal between the outlet 4120 and the upper cap outlet part 4214.

One or more third sealing members 4630 may be disposed between the lower cap member 4220 and the first filtering part 4300 to fill the gap between the lower cap member 4220 and the first filtering part 4300. For example, the third sealing member 4630 may be disposed between the first lower cap support part 4222 and the first filtering part 4300 and between the second lower cap support part 4223 and the first filtering part 4300.

Hereinafter, the action and effect of the filter assembly 23 according to an exemplary embodiment of the present invention will be described.

Raw water introduced through the inlet 4110 of the filter assembly 23 according to an exemplary embodiment of the present invention may be introduced into the first filtering part 4300 through the raw water flow path F1, filtered into purified water, and then discharged to the transfer flow path F2. The purified water flowing in the transfer flow path F2 may be re-filtered in the second filtering part 4400 and the third filtering part 4500 and then discharged to the purified water flow path F3. The purified water flowing in the purified water flow path F3 may be discharged to the outside through the cap hole 4211a and the outlet 4120.

Since the first filtering part 4300 may include a hollow fiber, it is possible to efficiently remove particulate matter, viruses, bacteria, etc. from raw water. Since the second filtering part 4400 may include a carbon filter, chemicals not filtered in the first filtering part 4300 can be removed and the taste of purified water can be improved. Since the third filtering part 4500 may include a positively charged layer, it is possible to remove some viruses and bacteria that are not filtered by the first filtering part 4300. In other words, excellent microorganism removal performance can be secured by the first filtering part 4300, the second filtering part 4400, and the third filtering part 4500.

In addition, since the first filtering part 4300, the second filtering part 4400, and the third filtering part 4500 can be replaced at once, ease of replacement can be secured.

Although the above has been described with reference to preferred embodiments of the present invention, it will be understood that those skilled in the art can variously modify and change the present invention without departing from the idea and scope of the present invention described in the claims below.

<Description of Symbols>

| | |
|---|---|
| 1: water purifier | 10: filter assembly |
| 20: raw water supply unit | 30: purified water discharge unit |
| 40: valve unit | 50: control unit |
| 100: housing | 110: accommodation space |
| 120: housing opening | 121: inlet part |
| 122: outlet part | 130: housing boss part |
| 131: inlet boss part | 132: outlet boss part |
| 200: cover unit | 210: first cover |
| 211: first plate part | 212: first outer |
| | circumferential part |
| 213: first inner | 214: cover through hole |
| circumferential part | |
| 215: cover neck part | 220: second cover |
| 221: second plate part | 222: second outer |
| | circumferential part |
| 223: second inner | 224: cover boss part |
| circumferential part | |
| 300: filter unit | 310: first filtering part |
| 311: strip | 311a: first end |
| 311b: second end | 311c: curved portion |
| 312: first membrane member | 320: second filtering part |
| 321: filtering member | 322: second membrane member |
| 330: inlet communication part | 331: main communication hole |
| 332: sub communication hole | 340: discharge hollow part |
| R.F: raw water flow path | |
| R.F1: first raw water | R.F2: second raw water |
| flow path | flow path |
| P.F1: first purified water | |
| flow path | |
| P.F2: second purified water | |
| flow path | |
| 21: filter assembly | 2010: frame |
| 2030: flow path unit | 2031: water inlet flow path |
| 2032: water outlet flow path | 2033: bypass flow path |
| 2034: drain flow path | 2040: valve unit |
| 2041: first valve module | 2042: second valve module |
| 2043: third valve module | 2050: control device |
| 2100: housing | 2110: inlet |
| 2120: outlet | 2200: cap |
| 2210: upper cap member | 2211: upper cap body part |
| 2211a: cap hole | 2212: first upper cap |
| | support part |
| 2213: second upper cap | 2214: upper cap |
| support part | outlet part |
| 2220: lower cap member | 2221: lower cap body part |
| 2222: first lower cap | 2223: second lower cap |
| support part | support part |
| 2300: first filtering part | 2310: fiber support |
| 2311: filter outer body | 2311a: communication hole |
| 2312: filter inner body | 2313: accommodation part |
| 2320: filter member | 2321: hollow fiber |
| 2321a: fiber passage | 2321b: through hole |
| 2400: second filtering part | 2500: sealing unit |
| 2510: first sealing member | 2520: second sealing member |
| 2530: third sealing member | |
| 22: filter assembly | 3010: frame |
| 3030: flow path unit | 3031: water inlet flow path |
| 3032: water outlet flow path | 3033: bypass flow path |
| 3034: drain flow path | 3040: valve unit |
| 3041: first valve module | 3042: second valve module |
| 3043: third valve module | 3050: control device |
| 3100: housing | 3110: inlet |
| 3120: outlet | 3200: cap |
| 3210: upper cap member | 3211: upper cap body part |
| 3211a: cap hole | 3212: first upper cap support part |
| 3213: second upper cap | 3214: upper cap |
| support part | outlet part |
| 3220: lower cap member | 3221: lower cap body part |
| 3222: first lower cap | 3223: second lower cap |
| support part | support part |
| 3300: first filtering part | 3310: fiber support |
| 3311: filter outer body | 3312: filter inner body |
| 3313: filter support body | 3313a: communication hole |
| 3314: first accommodation part | 3315: second accommodation part |
| 3320: filter member | 3321: hollow fiber |
| 3321a: fiber passage | 3321b: through hole |
| 3321c: extension part | 3321d: connection part |
| 3322: first filtering member | 3322a: first fiber support |
| 3322a-1: first passage | 3322a-2: first through hole |
| 3323: second filtering member | 3323a-1: second passage |
| 3323a-2: second through hole | 3400: second filtering part |
| 3500: sealing unit | 3510: first sealing member |
| 3520: second sealing member | 3530: third sealing member |
| 23: filter assembly | 4020: raw water line |
| 4030: purified water line | 4040: valve unit |
| 4041: raw water valve | 4042: purified water valve |
| 4100: housing | 4110: inlet |
| 4120: outlet | 4200: cap |
| 4210: upper cap member | 4211: upper cap body |
| 4211a: cap hole | 4212: first upper cap |
| | support part |
| 4213: second upper cap | 4214: upper cap outlet part |
| support part | |
| 4220: lower cap member | 4221: lower cap body |
| 4222: first lower cap | 4223: second lower cap |
| support part | support part |
| 4300: first filtering part | 4310: fiber support |
| 4311: accommodation part | 4312: filter outer body |
| 4312a: communication hole | 4313: filter inner body |
| 4320: filter member | 4321: hollow fiber |
| 4321a: fiber passage | 4321b: through hole |
| 4321c: extension part | 4321d: connection part |
| 4330: filter holder | 4400: second filtering part |
| 4500: third filtering part | 4600: sealing unit |
| 4610: first sealing member | 4620: second sealing member |
| 4630: third sealing member | |

What is claimed is:

1. A filter assembly, comprising:
a housing having an accommodation space formed therein so as to communicate with an external raw water supply unit and a purified water discharge unit, respectively;
a filter unit formed to extend from one direction toward the other direction and accommodated in the accommodation space of the housing such that raw water supplied from the external raw water supply unit is filtered, thereby generating purified water; and
a cover unit accommodated in the accommodation space of the housing so as to support the filter unit,
wherein the filter unit comprises:
a first filtering part configured such that the raw water supplied thereto is filtered while passing therethrough primarily; and
a second filtering part made of a different material from the first filtering part and positioned radially inside of the first filtering part such that the raw water that has passed through the first filtering part is filtered while passing therethrough secondarily,
wherein the first filtering part is formed to surround the radial outside of the second filtering part while being spaced apart from the second filtering part, and is provided as a hollow fiber membrane comprising multiple strips,
wherein the strip comprises:
one end and the other end positioned to be biased in the one direction; and
at least one curved portion continuous with the one end and the other end and positioned biased in the other direction, and
wherein the supplied raw water is filtered while passing through the first filtering part and the second filtering part, and is produced as purified water.

2. The filter assembly of claim 1, wherein the supplied raw water enters a hollow part extending inside the strip through a plurality of through holes formed on an outer circumferential surface of the strip and is filtered.

3. The filter assembly of claim 1, wherein the one end of the strip is positioned adjacent to the radial outer side of the first filtering part, and the other end of the strip is positioned adjacent to the radial inner side of the first filtering part.

4. The filter assembly of claim 1, wherein the plurality of strips are arranged such that a virtual straight line connecting the one end and the other end of any one of the plurality of strips intersects at least one point with a virtual straight line connecting the one end and the other end of the other one of the plurality of strips.

5. The filter assembly of claim 1,
wherein the filter unit extends in an up-down direction, and the strip comprises:
one end positioned adjacent to the radial outer side of the first filtering part, on the upper side of the filter unit;
a curved portion continuous with the one end and positioned adjacent to the lower side of the filter unit; and
the other end that is continuous with the curved portion, and is spaced apart from the one end and positioned adjacent to the radial inner side of the first filtering part, on the upper side of the filter unit.

6. The filter assembly of claim 1,
wherein the housing comprises: an inlet part through which the raw water supply unit and the accommodation space of the housing are communicated with each other to supply the raw water,
the filter unit is formed to extend in a direction away from the inlet part, and
a main communication hole, which is positioned adjacent to one end from which the filter unit extends, and is formed open to communicate the accommodation space into which the raw water is introduced and the inside of the first filtering part is formed on the radially outer surface of the first filtering part.

7. The filter assembly of claim 1,
wherein the filter unit comprises:
a discharge hollow part formed on a radial inner side of the second filtering part along its axial direction, and through which the purified water, produced by filtering the raw water while the raw water passing through the second filtering part, flows.

8. The filter assembly of claim 1,
wherein the filter unit is formed to extend from one direction toward the other direction, and
the cover unit comprises:
a first cover supporting an end of the filter unit in the one direction; and
a second cover supporting an end of the filter unit in the other direction.

9. A filter assembly, comprising:
a housing with a space formed therein;
a first filtering part accommodated inside the housing and providing purified water by filtering raw water; and
a second filtering part for filtering the raw water or the purified water,
wherein the first filtering part comprises a plurality of hollow fibers, and comprises a filter member that is spaced apart a predetermined distance outside the second filtering part when viewed from the top and extends to surround at least a portion of the second filtering part,
wherein each of the plurality of hollow fibers has a fiber passage extending along the longitudinal direction of the hollow fiber for the raw water to flow, and both ends of the fiber passage extend to be open toward opposite sides.

10. The filter assembly of claim 9, wherein the plurality of hollow fibers extend in the up-down direction so that one end of the fiber passage is open toward the upper side and the other end opposite to the one end is open toward the lower side.

11. The filter assembly of claim 9,
wherein the first filtering part further comprises a fiber support supporting the filter member,
a raw water flow path extending in the up-down direction is formed between the inner circumferential surface of the housing and the outer circumferential surface of the fiber support, and
a communication hole is formed in the fiber support for water to be introduced from the raw water flow path toward the filter member.

12. The filter assembly of claim 9,
wherein when viewed from the top, the first filtering part extends in a ring shape, and
the second filtering part is disposed inside the ring of the filter member in the radial direction.

13. A filter assembly, comprising:
a housing with a space formed therein;
a first filtering part accommodated inside the housing and providing purified water by filtering raw water; and
a second filtering part for filtering the raw water or the purified water,
wherein the first filtering part comprises a plurality of hollow fibers, and comprises a filter member that is spaced apart a predetermined distance outside the second filtering part when viewed from the top and extends to surround at least a portion of the second filtering part,
wherein each of the plurality of hollow fibers has a fiber passage extending along the longitudinal direction of the hollow fiber for the raw water to flow, and both ends of the fiber passage are bent to be open toward the same side.

14. The filter assembly of claim 13,
wherein the filter member comprises a first filter member and a second filter member disposed below the first filter member, and
the plurality of hollow fibers comprise first fibers provided to the first filtering member and second fibers provided to the second filtering member,
wherein the first fiber is bent so that both ends of a first passage formed in the first fiber are open upward, and
the second fiber is bent so that both ends of a second passage formed in the second fiber are open downward.

15. The filter assembly of claim 13,
wherein when viewed from the top, the first filtering part extends in a ring shape, and
the second filtering part is disposed inside the ring of the filter member in the radial direction.

16. A filter assembly, comprising:
a housing with a space formed therein;
a first filtering part accommodated inside the housing and providing purified water by filtering raw water;
a second filtering part for filtering the purified water; and
a third filtering part comprising a positively charged layer for filtering the purified water,
wherein the first filtering part comprises a plurality of hollow fibers, and is spaced apart a predetermined distance outside the second filtering part and the third filtering part when viewed from the top and extends to surround at least a portion of the second filtering part and the third filtering part.

17. The filter assembly of claim 16, wherein when viewed from the top, the third filtering part extends to surround at least a portion of the second filtering part.

18. The filter assembly of claim 16, wherein the second filtering part comprises a carbon filter.

19. The filter assembly of claim 16,
further comprising a cap disposed inside the housing to support the first filtering part, the third filtering part, and the second filtering part,
wherein the cap comprises:
an upper cap member supporting the upper sides of the first filtering part, the second filtering part, and the third filtering part, and being disposed to be spaced apart by a predetermined distance from the upper end of the first filtering part; and
a lower cap member supporting the lower side of the first filtering part, the lower side of the second filtering part, and the lower side of the third filtering part.

20. The filter assembly of claim 16,
wherein an inlet through which the raw water is introduced and an outlet through which the purified water is discharged are formed in the housing,
one of the inlet and the outlet is formed on one surface of the housing, and
the other is formed on the one surface of the housing or the other surface opposite to the one surface.
